(19) United States
(12) Patent Application Publication
(10) Pub. No.: US 2009/0213110 A1
(43) Pub. Date: Aug. 27, 2009

(54) IMAGE MIXING APPARATUS AND PIXEL MIXER

(76) Inventors: Shuhei Kato, Shiga (JP); Koichi Sano, Shiga (JP); Koichi Usami, Shiga (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/570,982

(22) PCT Filed: Jun. 24, 2005
(86) PCT No.: PCT/JP2005/012147

§ 371 Date: Feb. 3, 2009

(30) Foreign Application Priority Data
Jun. 25, 2004 (JP) 2004-187678

(51) Int. Cl. G06T 1/00

(52) U.S. Cl. 345/418

(57) ABSTRACT

An image mixing apparatus and a pixel mixer capable of mixing image data items having different pixel resolutions, and mixing image data items in an arbitrary display priority, irrespective of the order of mixing, even if the order of mixing is determined in advance is provided. Of two pixel data items having depth values “Zc” and “Zb”, one pixel data item having the depth value indicating that the pixel is located in a foreground position is selected by a pixel selection determination circuit 110. However, if a pixel data item has a hue indicating that the pixel is transparent, such a pixel data item is not selected but another pixel data item is selected instead. Multiplexers 112 to 116 output a pixel data item (hue “Hm”/color saturation “Sm”/brightness “Lm”) which is selected by the pixel selection determination circuit 110. Since pixel data items are input to the multiplexer 112 to 116 at different output rates, it is possible to mix images having different pixel resolutions.

### TECHNICAL FIELD

The present invention relates to an image mixing apparatus and a pixel mixer for mixing a plurality of image data items on a display screen in real time.

### BACKGROUND ART

FIG. 18 is an explanatory view for showing a prior art image processing system which has been disclosed in FIG. 11 of Japanese Patent Published Application No. Hei 7-104733. As shown in FIG. 18, an external device 550 outputs image data 590, priority information 600 indicative of whether the image data 590 is located over or under image data 620 of an external device 560, and information 610 indicative of whether the respective pixels of the image data 590 are transparent or not transparent. On the other hand, the external device 560 outputs the image data 620 and information 630 indicative of whether the respective pixels of the image data 620 are transparent or not transparent.

On the basis of the priority information 600 and the information 610 and 630 indicative of whether or not the respective pixels are transparent, a display image data decision circuit 580 determines which the image data 590 or 620 is selected for each pixel. Then, a selector 570 selects and outputs the image data determined by the display image data decision circuit 580 of the image data 590 and 620 as input thereto. By this configuration, it is possible to mix and output image data on a real time base. However, in accordance with such a prior art image processing system, it is impossible to mix image data items having different resolutions. In addition to this, it is impossible to freely determine the display priority, which is depending upon the order of mixing the images. This point can be explained in detail as follows.

If the above image processing system is used as an example, more image data items can be mixed by providing a plurality of such systems as described above. It is assumed here that mixed image data provided by mixing a first image data item and a second image data item is mixed further with a third image data item. In this case, as seen from the resultant data, the mixed image data of the first image data item and the second image data item is merely one image data item. Accordingly, the process of mixing this mixed image data with the third image data item is equivalent to the process of combining two image data items, and cannot be recognized as mix of three image data items. Thus, in the case of such a mixing, it is impossible to prepare mixed image data in order that the first image data item is located in the back side, that the second image data item is located in the front side, and that the third image data item is located therebetween. This is because the order of mixing is determined in advance.

### DISCLOSURE OF INVENTION

It is therefore an object of the present invention to provide an image mixing apparatus and a pixel mixer capable of mixing image data items having different resolutions, and mixing image data items in an arbitrary display priority, irrespective of the order of mixing, even if the order of mixing is determined in advance.

In accordance with the first aspect of the present invention, an image mixing apparatus is operable to mix on a display screen a plurality of images each of which has a different width of pixels relative to the display screen, said image mixing apparatus comprising: a plurality of pixel output units operable to output pixel data items each of which includes color information and a depth value of the corresponding image at output rates which are set respectively for said pixel output units; and a pixel mixer operable to receive the pixel data items as output from said plurality of pixel output units, and output the color information of the pixel data item whose the depth value indicates, among the depth values of the pixel data items, that the pixel corresponding thereto is located in a foreground position among the pixels corresponding to the pixel data items, wherein the depth value is a value indicative of the depth position of the pixel of the corresponding image, wherein the color information is information indicative of a color of the pixel forming the corresponding image, and wherein the output rates of at least two of said pixel output units are set to different values.

By this configuration, the pixel mixer determines the color information of the pixel to be output in accordance with the depth values of the pixels input from the respective pixel output units and mixes the plurality of images. In this case, since pixel data items are input to the pixel mixer from the respective pixel output units at different output rates, it is possible to mix the images having different widths of pixels, i.e., having different horizontal pixel resolutions.

In addition, the pixel data items output from the respective pixel output units contains the depth values. In other words, a depth value is associated with each pixel of the respective images to be mixed. Then, if pixels overlap, the pixel mixer makes a selection of one of the pixels on the basis of the depth values of the respective pixels. Because of this, the foreground-background relationship is not determined between the respective images to be mixed. Namely, the foreground-background relationship is determined between the respective pixels at the same position of the respective images to be mixed.

Accordingly, it is possible to mix the images to be mixed in order that one image is placed behind a first area of another image and over a second area of this another image. In this manner, it is possible not only to set the order of display priority for the respective images to be mixed and recognized respectively as inseparable, but also to set the order of display priority for the constituent elements of each image.

Furthermore, even in the case where a mixed image generated by an image mixing operation on the basis of depth values is mixed again with another image, since the mixed image contains the depth values of the respective pixels, it is possible to mix a plurality of images in accordance with an desired order of display priority irrespective of the order of mixing.

In accordance with the second aspect of the present invention, an image mixing apparatus is operable to mix on a display screen a plurality of images each of which has a different width of pixels relative to the display screen, said image mixing apparatus comprising: a plurality of pixel output units operable to output pixel data items each of which includes color information and a depth value of the corresponding image at output rates which are set respectively for said pixel output units; and a pixel mixer operable to receive the pixel data items as output from said plurality of pixel output units, and output the color information of the pixel data item whose the depth value indicates, among the depth values of the pixel data items, that the pixel corresponding thereto is located in a foreground position among the pixels corresponding to the pixel data items, wherein the depth value is a value indicative of the depth position of the pixel of the corresponding image, wherein the color information is information indicative of a color of the pixel forming the corresponding image, and wherein at least one of said pixel output units is provided with a storage unit which is used to set the output rate and can be rewritten by an external device.

By this configuration, it is possible to arbitrarily set the output rate of a pixel output unit and make use of a different output rate from that of another pixel output unit. The pixel mixer determines the color information of the pixel to be output in accordance with the depth values input from the respective pixel output units and mixes the plurality of images. In this case, since pixel data items can be input to the pixel mixer from the respective pixel output units at different output rates, it is possible to mix the images having different widths of pixels, i.e., having different horizontal pixel resolutions.

In addition to this, it is possible not only to set the order of display priority for the images to be mixed and recognized respectively as inseparable, but also to set the order of display priority for the constituent elements of each image, in the same manner as the image mixing apparatus in accordance with the first aspect of the present invention.

Furthermore, even if the order of mixing images is fixed, it is possible to mix a plurality of images in an desired order of display priority irrespective of the order of mixing, in the same manner as the image mixing apparatus in accordance with the first aspect of the present invention.

In the image mixing apparatus of the first aspect or the second aspect of the present invention, said pixel mixer does not output the color information of the pixel data item, if the color information of the pixel data item indicates that the pixel is transparent, irrespective of the depth value of the pixel data item, while said pixel mixer outputs the color information of the pixel data item having the depth value which indicates that the pixel corresponding thereto is located in a foreground position among the depth values corresponding to the pixel data items that have the color information indicative of non-transparent colors.

By this configuration, since any transparent pixel is not selected and output, even if the selection of pixels are made on the basis of the depth values, the transparent pixel is not selected and output even though it is placed in a foreground position, and therefore it is possible to select and output an appropriate pixel corresponding to the image as intended.

In the image mixing apparatus of the first aspect or the second aspect of the present invention, the image mixing apparatus as claimed in claim 1 further comprises: a timing generator including a first counter and operable to generate first scan count information indicative of a first scan position by the counter value of the first counter; and a video position adjuster including a second counter, operable to generate second scan count information indicative of a second scan position with reference to the counter value of the second counter, and operable to initialize the second counter when the counter value indicated by the first scan count information matches an offset value, wherein, at least one of said pixel output units outputs the pixel data at the output rate as set for said pixel output unit in the output timing on the basis of the first scan count information, and said other pixel output unit outputs the pixel data at the output rate as set for said other pixel output unit in the output timing on the basis of the second scan count information.

By this configuration, it is possible to arbitrarily adjust the position of the image as output on the display screen on the basis of the second scan count information by adjusting the offset value. In addition, it is possible to adjust the relative display position between the image as output on the basis of the first scan count information and the image as output on the basis of the second scan count information.

In the image mixing apparatus of the first aspect or the second aspect of the present invention, the image mixing apparatus as claimed in claim 1 further comprises: a timing generator including a first counter and a second counter, operable to generate first horizontal scan count information indicative of a first horizontal scan position by the counter value of the first counter, and operable to generate first vertical scan count information indicative of a first vertical scan position by the counter value of the second counter which operates on the basis of the first horizontal scan count information; and a video position adjuster including a third counter and a fourth counter, operable to generate second horizontal scan count information indicative of a second horizontal scan position by the counter value of the third counter, operable to initialize the third counter when the counter value indicated by the first horizontal scan count information matches a horizontal offset value and generate second vertical scan count information indicative of a second vertical scan position by the counter value of the fourth counter, and operable to initialize the fourth counter when the counter value indicated by the first vertical scan count information matches a vertical offset value, wherein, at least one of said pixel output units outputs the pixel data at the output rate as set for said pixel output unit in the output timing on the basis of the first horizontal scan count information and the first vertical scan count information, and said other pixel output unit outputs the pixel data at the output rate as set for said other pixel output unit in the output timing on the basis of the second vertical scan count information.

By this configuration, it is possible to arbitrarily adjust the position of the image, on the display screen, as output on the basis of the second horizontal scan count information and the second vertical scan count information by adjusting the horizontal offset value and the vertical offset value. In addition, it is possible to adjust the relative display position between the image as output on the basis of the first horizontal scan count information and the first vertical scan count information and the image as output on the basis of the second horizontal scan count information and the second vertical scan count information.

In the image mixing apparatus of the first aspect or the second aspect of the present invention, the image mixing apparatus as claimed in claim 1 further comprises: a timing generator including a first counter and operable to generate first scan count information indicative of a first scan position by the counter value of the first counter; and a video position adjuster including a second counter, operable to generate second scan count information indicative of a second scan position by the counter value of the second counter, and operable to initialize the second counter when the counter value indicated by the first scan count information matches an offset value, wherein, at least one of said pixel output units reads a color code designating the color information of the pixel from a first memory area in accordance with the first scan count information, converts the color code into the color information, and outputs, as the pixel data item, the color information together with the depth value at the output rate as set for said pixel output unit, and said other pixel output unit reads a color code designating the color information of the pixel from a second memory area in accordance with the second scan count information, converts the color code into the color information, and outputs, as the pixel data item, the color information together with the depth value at the output rate as set for said other pixel output unit.

By this configuration, it is possible to arbitrarily adjust the position of the image, on the display screen, which consists of color codes as read from the second memory area on the basis of the second scan count information by adjusting the offset value. In addition, it is possible to adjust the relative display position between the image which consists of color codes as read from the first memory area on the basis of the first scan count information and the image which consists of color codes as read from the second memory area on the basis of the second scan count information.

In the image mixing apparatus of the first aspect or the second aspect of the present invention, the image mixing apparatus as claimed in claim 1 further comprises: a timing generator having a first counter and a second counter, operable to generate first horizontal scan count information indicative of a first horizontal scan position by the counter value of the first counter, and generate first vertical scan count information indicative of a first vertical scan position by the counter value of the second counter which operates on the basis of the first horizontal scan count information; and a video position adjuster having the third counter and the fourth counter, operable to generate second horizontal scan count information indicative of a second horizontal scan position by the counter value of the third counter, operable to initialize the third counter when the counter value indicated by the first horizontal scan count information matches a horizontal offset value and generate second vertical scan count information indicative of a second vertical scan position by the counter value of the fourth counter, and operable to initialize the fourth counter when the counter value indicated by the first vertical scan count information matches a vertical offset value, wherein, at least one of said pixel output units reads a color code for designating the color information of the pixel from a first memory area in accordance with the first horizontal scan count information and the first vertical scan count information, converts the color code into the color information, and outputs the color information, as the pixel data item, together with the depth value at the output rate as set for said pixel output unit, and said other pixel output unit reads a color code for designating the color information of the pixel from a second memory area in accordance with the second horizontal scan count information and the second vertical scan count information, converts the color code into the color information, and outputs the color information, as the pixel data item, together with the depth value at the output rate as set for said other pixel output unit.

By this configuration, it is possible to arbitrarily adjust the position of the image, on the display screen, which consists of color codes as read from the second memory on the basis of the second horizontal scan count information and the second vertical scan count information by adjusting the horizontal offset value and the vertical offset value. In addition, it is possible to adjust the relative display position between the image which consists of color codes as read from the first memory area on the basis of the first scan horizontal count information and the first vertical scan count information and the image which consists of color codes as read from the second memory area on the basis of the second scan horizontal count information and the second vertical scan count information.

In the image mixing apparatus of the first aspect or the second aspect of the present invention, the image mixing apparatus as claimed in claim 1 further comprises: a plurality of color palettes provided respectively in association with said plurality of pixel output units in order that each color palette stores a plurality of items of the color information which are associated respectively with a plurality of color codes, wherein said pixel output unit reads the color code from a memory on the basis of scan position information, extracts the color information associated with the color code, as read, from said corresponding color palette, and outputs the color information, as the pixel data item, to said pixel mixer together with the depth value at the output rate as set for said pixel output unit.

By this configuration, there are the color palettes provided respectively for the pixel output units, i.e., respectively for the images to be mixed. Generally speaking, in the case of a system making use of a color palette for converting a color code into color information, the color code is composed of a fewer number of bits than the color information so that there is an advantage that the image data can occupy only a smaller area of a memory in which the image data is stored, but there is a disadvantage that the range of colors as available on the same screen is narrowed. Contrary to this, in accordance with this configuration of the image mixing apparatus, the separate color palettes are provided respectively for the color output units, and therefore it is possible to increase the number of colors as available on the same screen without increasing the size of the image data and extend the range of color expression for greater diversity.

In the image mixing apparatus as recited above, the image mixing apparatus as claimed in claim 7 wherein said pixel output unit comprises: a first register operable to store a value which is used to adjust the horizontal position of the image on the display screen; a second register operable to store a value which is used to set a pixel resolution in the horizontal direction; a pixel clock generation circuit operable to generate a pixel clock signal of a frequency corresponding to the pixel resolution as set in said second register; and a horizontal counter operable to perform a count operation in the clock cycle of the pixel clock signal, and indicate the horizontal position of the image on the display screen by the counter value thereof, wherein said horizontal counter is initialized when the counter value indicated by the first horizontal scan count information matches the value stored in said first register.

By this configuration, since the horizontal counter for regulating the horizontal position of an image to be mixed is initialized by the use of the horizontal position adjustment value as set in the first register, it is possible to fine-adjust this horizontal position by setting an appropriate value in the first register.

In the image mixing apparatus of the first aspect or the second aspect of the present invention, the image mixing apparatus as claimed in claim 1 wherein at least one of said pixel output units reads data in words from a memory of which one word consists of N bits (N is 2 or larger integer), extracts, on a pixel-by-pixel basis, color codes each of which represents one pixel by M bits (M is 1 or a larger integer) and which are continuously arranged in the memory without space therebetween, converts the color code as extracted into the color information, and outputs the color information to said pixel mixer together with the depth value at the output rate as set for said at least one of said pixel output units.

Since the pixel output unit extracts the data corresponding to one pixel from the data which is read from the memory, it is possible to continuously arrange the data in the memory in order not to leave unused bits therebetween in the respective words irrespective of the number of bits per pixel (color mode). In other words, regardless of whether or not each of N/M and M/N is an integer, it is possible to fill an area of the memory with the data in order not to leave unused bits therebetween in the respective words. Because of this, the memory area can be efficiently and effectively used.

In accordance with the third aspect of the present invention, a pixel mixer is operable to mix a plurality of images each of which consists of a plurality of pixels, at least two of the plurality of images having different pixel resolutions, each of the pixels being represented by a pixel value and a depth value, said pixel mixer comprises: a pixel selection determination unit operable to successively and concurrently receive the depth values of the pixels of the plurality of images, at the rate of receiving pixels corresponding to the pixel resolution of each image whereby the rates of receiving depth values of at least two images are different, compare the depth values of the pixels, that are currently and simultaneously received, for determining which of the currently received pixels is located in the most foreground position every time at least one depth value changes, and output a select signal indicative of the currently received pixel as determined to be located in the most foreground position; and a selector unit connected to said pixel selection determination unit, operable to successively and concurrently receive the pixel values of the pixels of the plurality of images together with the select signal in synchronization with the reception of the depth values by said pixel selection determination unit, select one of the pixel values, that are currently and simultaneously received, on the basis of the select signal, and output the pixel value as selected.

By making use of the pixel mixer as described above, it is possible to easily construct an image mixing apparatus which can display images having different resolutions on the same display screen.

### BRIEF DESCRIPTION OF DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a block diagram showing the overall configuration of a processor 1000 as a data processing unit in accordance with an embodiment of the present invention.

FIG. 2A is a schematic view showing the image mixing process by the use of the processor 1000 illustrated in FIG. 1.

FIG. 2B is an exemplary view showing a mixed image generated by the processor 1000 illustrated in FIG. 1.

FIG. 3 is an explanatory view for showing a bitmap screen which is generated by the processor 1000 of FIG. 1.

FIG. 4 is an explanatory view for showing the horizontal position fine adjustment of the bitmap screen “BS” in accordance with the present embodiment.

FIG. 5A is a view showing an example of the display image of the display area “DA” of FIG. 3 which is displayed at a horizontal pixel resolution of 8 clocks per pixel.

FIG. 5B is a view showing an example of the display image of the display area “DA” of FIG. 3 which is displayed at a horizontal pixel resolution of 4 clocks per pixel.

FIG. 6 is an explanatory view for showing the method of setting the addresses required for obtaining the bitmap data of the bitmap screen “BS” in accordance with the present embodiment.

FIG. 7 is a view for explaining the function of adjusting the display position of the character screen by the processor 1000 of FIG. 1.

FIG. 8 is a block diagram showing the front part of the internal configuration of the graphics processor 3 of FIG. 1.

FIG. 9 is a block diagram showing the subsequent part of the internal configuration of the graphics processor 3 of FIG. 1.

FIG. 10 is a block diagram showing the internal configuration of a pixel mixer 90 of FIG. 9.

FIG. 11 is a truth table for determining the selected pixel by means of the pixel mixer 90 of FIG. 9.

FIG. 12 is a timing chart showing an exemplary process of image mixing by the pixel mixer 90 of FIG. 9.

FIG. 13 is a block diagram showing the internal configuration of a color palette controller 82 of FIG. 9.

FIG. 14 is a timing chart to explain the action of a pixel output control circuit 144 of FIG. 13.

FIG. 15 is a block diagram showing the internal configuration of a bitmap generator 86 of FIG. 9.

FIG. 16 is a view for explaining the operation of a funnel shifter 216 and the upper bit mask circuit 218 of FIG. 15.

FIG. 17 is a block diagram showing the internal configuration of the video position adjuster 102 of FIG. 9.

FIG. 18 is an explanatory view for showing a prior art image processing system.

### BEST MODE FOR CARRYING OUT THE INVENTION

In what follows, an embodiments of the present invention will be explained in conjunction with the accompanying drawings. Meanwhile, like references indicate the same or functionally similar elements throughout the respective drawings, and therefore redundant explanation is not repeated. Also, when it is necessary to specify a particular bit or bits of a signal in the description or the drawings, [a] or [a:b] is suffixed to the name of the signal. While [a] stands for the a-th bit of the signal, [a:b] stands for the a-th to b-th bits of the signal. In regard to the hexadecimal expression, “H” is suffixed to the number in order to distinguish it from the decimal expression. Also, while a prefixed “0b” is used to designate a binary number, a prefixed “0x” is used to designate a hexadecimal number.

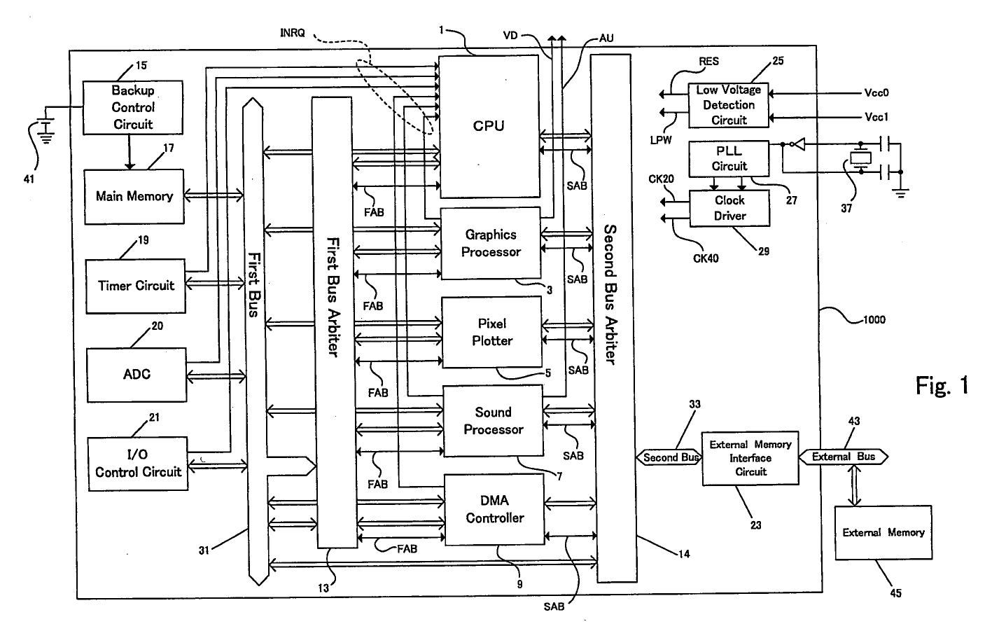

FIG. 1 is a block diagram showing the overall configuration of a processor 1000 as a data processing unit in accordance with an embodiment of the present invention. As shown in FIG. 1, this processor 1000 includes a central processing unit (CPU) 1, a graphics processor 3, a pixel plotter 5, a sound processor 7, a DMA (direct memory access) controller 9, a first bus arbiter 13, a second bus arbiter 14, a backup control circuit 15, a main memory 17, a timer circuit 19, an analog-to-digital converter (ADC) 20, an input/output control circuit 21, an external memory interface circuit 23, a clock driver 29, a PLL (phase-locked loop) circuit 27, a low voltage detection circuit 25, a first bus 31 and a second bus 33.

In the present embodiment, the main memory 17 and an external memory 45 are generally referred to as the “memory MEM” in the case where they need not be distinguished.

The CPU 1 performs various operations and controls the overall system in accordance with a program stored in the memory MEM. The CPU 1 is a bus master of the first bus 31 and the second bus 33, and can access the resources connected to the respective buses.

The graphics processor 3 is a bus master of the first bus 31 and the second bus 33, and serves to convert the data stored in the memory MEM into graphic data, and generate a video signal “VD” to be output to a television receiver (not shown in the figure) on the basis of the graphic data.

In this case, the graphic data is generated by synthesizing a background screen(s), a sprite(s) and a bitmap screen. The background screen which covers entirety of the screen of a television receiver comprises a two-dimensional array. And each array element comprises of a rectangular set of pixels. There are a first background screen and a second background screen respectively prepared as the background screen for showing depths in the background. The sprite consists of a rectangular set of pixels which can be relocated in any position of the screen of a television receiver. The rectangular set of pixels constituting each of the background screens or sprites is referred to as a character. The bitmap screen consists of a two-dimensional pixel array of which the size and location as displayed can be freely designated.

Also, the graphics processor 3 is controlled by the CPU 1 through the first bus 31, and capable of issuing an interrupt request signal “INRQ” to the CPU 1.

The pixel plotter 5 is controlled by the CPU 1 through the first bus 31, and capable of drawing pixel data as given from the CPU 1. In this example, the drawing operation can be performed with individual pixels. Pixel data as described herein is data representing the display color of one pixel by M bits (M is one or a larger integer). In the present embodiment, M=1 to 8 as an example.

Also, the pixel plotter 5 makes it possible to perform high-speed drawing and effectively use the buses (the first bus 31 and the second bus 33) by virtue of a cache system. Furthermore, the pixel plotter 5 is a bus master of the first bus 31 and the second bus 33, and capable of autonomously writing data from a cache (not shown in the figure) to the memory MEM and from the memory MEM to the cache.

The sound processor 7 is a bus master of the first bus 31 and the second bus 33, and serves to convert data stored in the memory MEM into sound data, and generate and output an audio signal “AU” on the basis of the sound data.

The sound data is synthesized by pitch conversion and amplitude modulation of PCM (pulse code modulation) data serving as the base data of tone quality. For the amplitude modulation, an envelope control function for reproducing waveforms of a music instrument is provided in addition to a volume control function performed in response to an instruction of the CPU 1.

Furthermore, the sound processor 7 is controlled by the CPU 1 through the first bus 31, and capable of issuing an interrupt request signal “INRQ” to the CPU 1.

The DMA controller 9 controls data transfer from the external memory 45 connected to an external bus 43 to the main memory 17. The external memory 45 may be implemented with, for example, an SRAM (static random access memory), a DRAM (dynamic random access memory), a ROM (read only memory) or any other appropriate memory, or implemented as a combination of any number of such memories. On the other hand, the DMA controller 9 has the function of outputting, to the CPU 1, an interrupt request signal “INRQ” indicative of the completion of the data transfer. Particularly, the DMA controller 9 is a bus master of the first bus 31 and the second bus 33, and controlled by the CPU 1 through the first bus 31.

The main memory 17 may be implemented with one or any necessary combination of a mask ROM, an SRAM and a DRAM in accordance with the system requirements. In the present embodiment, the main memory 17 is composed of an SRAM.

The backup control circuit 15 deactivates the main memory 17 when the low voltage detection circuit 25 to be described below detects a low voltage condition. On the other hand, the main memory 17 is supplied with a power supply voltage from the battery 41. Accordingly, the data stored in the main memory 17 composed of the SRAM can be maintained even after the power supply voltages Vcc0 and Vcc1 are taken away.

The first bus arbiter 13 accepts first bus use request signals from the respective bus masters of the first bus 31, performs bus arbitration among the requests, and issues a first bus use acknowledge signal to one of the respective bus masters for each bus cycle. More specifically speaking, while there are multiple sets of priority level information relating to the priority levels (priority rankings) assigned to a plurality of the bus masters in regard to the use of the first bus 31, the first bus arbiter 13 performs arbitration on the basis of one of the multiple sets of priority level information which is sequentially and cyclically selected.

Each bus master is permitted to access the first bus 31 after receiving the first bus use acknowledge signal. In this example, the first bus use request signal and the first bus use acknowledge signal are illustrated as first bus arbitration signals “FAB” in FIG. 1.

For example, the first bus 31 includes a first data bus of 8 bits, a first address bus of 15 bits and a first control bus (not shown in the figure).

The second bus arbiter 14 accepts second bus use request signals from the respective bus masters of the second bus 33, performs bus arbitration among the requests, and issues a second bus use acknowledge signal to one of the respective bus masters for each bus cycle or each sequence of a predetermined number of bus cycles corresponding to the number of bytes as required. More specifically speaking, while there are multiple sets of priority level information relating to the priority levels assigned to a plurality of the bus masters in regard to the use of the second bus 33, the second bus arbiter 14 performs arbitration on the basis of one of the multiple sets of priority level information which is sequentially and cyclically selected.

Each bus master is permitted to access the second bus 33 after receiving the second bus use acknowledge signal. In this example, the second bus use request signal and the second bus use acknowledge signal are illustrated as second bus arbitration signals “SAB” in FIG. 1.

For example, the second bus 33 consists of a 16-bit second data bus, a 27-bit second address bus, and a second control bus (not shown in the figure).

The timer circuit 19 has the function of repeatedly outputting an interrupt request signal “INRQ” to the CPU 1 with a configured interval. The setting of the time interval and so forth is performed by the CPU 1 through the first bus 31.

The ADC 20 converts an analog input signal to a digital signal. This digital signal is read by the CPU 1 through the first bus 31. In addition, the ADC 20 has the function of outputting an interrupt request signal “INRQ” to the CPU 1. In addition, an analog signal as output from an external device is input to the ADC 20, for example, through any one of six analog ports “AIN0” to “AIN5” (not shown in the figure).

The input/output control circuit 21 serves to perform the input and output operations of input and output signals to enable the communication with external input/output devices and/or external semiconductor devices. The read and write operations of input and output signals are controlled by the CPU 1 through the first bus 31. Also, the input/output control circuit 21 has the function of outputting an interrupt request signal “INRQ” to the CPU 1. Incidentally, the input and output signals are input and output, for example, through programmable input/output ports “IO0” to “IO23” (not shown in the figure).

The low voltage detection circuit 25 monitors the power supply voltages Vcc0 and Vcc1, and issues a reset signal “LPW” to the PLL circuit 27 and so forth and a reset signal “RES” to the other circuit elements of the entire system when either the power supply voltage Vcc0 or Vcc1 falls below corresponding one of reference voltages which are determined in advance individually for the respective power supply voltages Vcc0 and Vcc1. The reset signal “LPW” is output in order to protect the system at power up or down and perform the initialization of the system. The reset signal “RES” is output in order to initialize the system at power up or after restart. When the reset signal “LPW” is made active, the reset signal “RES” is also made active at the same time and maintained in its active state, even after the reset signal “LPW” is deactivated, for a short time.

In this case, the power supply voltage Vcc0 is for example +2.5 V, which is supplied mainly to digital circuits in the processor 1000. On the other hand, the power supply voltage Vcc1 is for example +3.3 V, which is supplied mainly to analog circuits and I/O circuits in the processor 1000.

The PLL circuit 27 generates a high frequency clock signal by multiplication of the sinusoidal signal as obtained from a crystal oscillator 37. The frequency of the crystal oscillator 37 has to be determined in order to generate an NTSC standard signal or a PAL standard signal from the output thereof. In this case, the frequency of the color sub-carrier of the NTSC standard or the PAL standard is used as the frequency of the crystal oscillator 37 such that the price of a crystal oscillator is lowest. Specifically speaking, the frequency of the crystal oscillator 37 is 3.579545 MHz in the case of NTSC and 4.43361875 MHz in the case of PAL.

Since the frequency of a crystal oscillator as required is different between NTSC and PAL, the multiplication ratio of the PLL circuit 27 is changed between NTSC and PAL in order to output clock signals whose frequency are roughly equal. Specifically speaking, the frequency of the input signal is multiplied by 96/8 in the case of NTSC to output a clock signal “ck40”, and the frequency of the input signal is multiplied by 96/10 in the case of PAL to output a clock signal “ck40”. Furthermore, the PLL circuit 27 generates a clock signal “ck20” by dividing the clock signal “ck40” by 2.

The clock driver 29 receives the high frequency clock signals “ck40” and “ck20” from the PLL circuit 27, amplifies these signals to a sufficient driving capability, and supplies these signals to the respective blocks as internal clock signals “CK40” and “CK20”.

The external memory interface circuit 23 has the function of connecting the second bus 33 to the external bus 43.

Next, the data transfer paths within the processor 1000 shown in FIG. 1 will be explained. For example, in the case where the CPU 1 controls, as a bus master, one of the other functional blocks (the graphics processor 3, the pixel plotter 5, the sound processor 7, the DMA controller 9, the first bus arbiter 13, the second bus arbiter 14 and the like) respectively connected to the first bus 31 as a bus slave, the CPU 1 outputs write data to the first bus arbiter 13 for writing the write data to the control register of the functional block and, after arbitration, the first bus arbiter 13 transmits the write data to the control register through the first bus 31, while the CPU 1 receives read data transmitted from the control register of the functional block after arbitration through the first bus 31 and the first bus arbiter 13. On the other hand, each of the graphics processor 3, the pixel plotter 5, the sound processor 7 and the DMA controller 9 has the function of outputting the first bus use request signal to the first bus arbiter 13 as a bus master of the first bus 31.

When accessing the main memory 17, a bus master outputs write data to the first bus arbiter 13 for writing the write data to the main memory 17 and the first bus arbiter 13 transmits the write data to the main memory 17 after arbitration through the first bus 31, while a bus master receives read data from the main memory 17 after arbitration through the first bus 31 and the first bus arbiter 13. Also, when accessing the external memory 45, a bus master outputs write data to the second bus arbiter 14 for writing the write data to the external memory 45 and the second bus arbiter 14 transmits the write data to the external memory 45 after arbitration through the second bus 33, the external memory interface circuit 23 and the external bus 43, while a bus master receives the read data from the external memory 45 after arbitration through the external bus 43, the external memory interface circuit 23, the second bus 33 and the second bus arbiter 14.

By the way, in accordance with the present embodiment, the processor 1000 is capable of mixing image data items having different resolutions, and mixing image data items in an arbitrary order of display priority, irrespective of the order of mixing, even if the order of mixing is determined in advance. A brief outline of this process will be explained with reference to drawings.

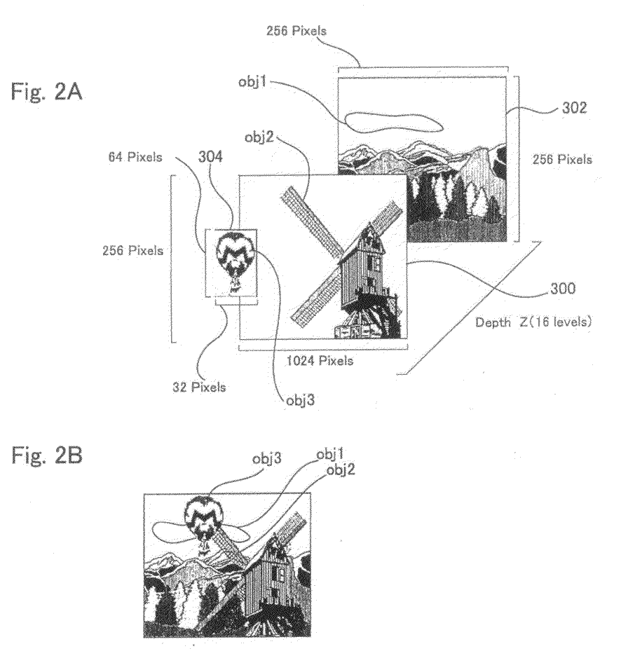

FIG. 2A is a schematic view showing the image mixing process by the use of the processor 1000 illustrated in FIG. 1; and FIG. 2B is an exemplary view showing a mixed image thereof. As shown in FIG. 2A, a sprite 304 consisting of 64 pixels (height)×32 pixels (width), a bitmap screen 300 consisting of 256 pixels (height)×1024 pixels (width) and a background screen 302 consisting of 256 pixels (height) of 256 pixels (width) are considered here. Also, the sprite 304 and the background screen 302 consist of character(s) each of which consists of 16 pixels (height)×16 pixels (width).

Furthermore, the depth values “Z” of the sprite 304, the bitmap screen 300 and the background screen 302 are respectively “FH”, “9H” and “3H”. In this case, a depth value “Z” indicates a depth position of a pixel by a four-bit value. Namely, a depth value “Z” can takes a value from “0H” (rearmost position) to “FH” (topmost position). When a plurality of pixels are located in the same position, the foreground pixel having the largest depth value “Z” is selected from thereamong.

At first, as shown in FIG. 2A, the processor 1000 mixes together the sprite 304 and the background screen 302 in accordance with their depth values “Z”.

For the sake of clarity in explanation, the screen generated by mixing the sprite 304 and the background screen 302 is referred to herein as a character screen. The size of the each pixel of the sprite 304 is equal to the size of the each pixel of the background screen 302, therefore all sprites to be displayed are mixed with a background screen to be a character screen consisting of 224 pixels (height) of 256 pixels (width). Accordingly, in this example, the horizontal resolution of the bitmap screen 300 is 4 times of the horizontal resolution of the character screen.

On the other hand, each pixel of the character screen is associated with either the depth value “Z” of the original sprite 304 or the original background screen 302.

Next, the processor 1000 combines together the character screen and the bitmap screen 300 in accordance with the depth values “Z” of the respective pixels. More specifically speaking, the graphics processor 3 selects and outputs the foreground pixel having the largest depth value “Z” from among a plurality of the pixels overlapping each other. However, the processor 1000 refers to the transparency information of each pixel for selecting one pixel from among coincident pixels in order that, if a pixel is transparent, the pixel is not selected irrespective of its depth value “Z” and the pixel having the next largest depth value “Z” is selected in place thereof.

For example, if the depth value “Z” of a certain pixel of the character screen is “FH” and the depth value “Z” of the pixel of the bitmap screen 300 overlapping said certain pixel is “9H”, then said certain pixel of the character screen is selected. However, for example, even if the depth value “Z” of a certain pixel of the character screen is “FH” and the depth value “Z” of the pixel of the bitmap screen 300 overlapping said certain pixel is “9H”, the pixel of the bitmap screen 300 is selected in the case where said certain pixel of the character screen is transparent.

As has been discussed above, the processor 1000 mixes together the character screen and the bitmap screen 300 having different resolutions on the basis of the depth values “Z” and the transparent information. As a result, the mixed image as illustrated in FIG. 2B is generated. Incidentally, FIG. 2B only shows the display area of the mixed image as generated. The image mixing method will be described below in detail.

Also, as has been discussed above, the mixing performed in order that the sprite 304 and the background screen 302 are first mixed together and then the character screen generated by the first mixing is mixed with the bitmap screen 300. Thus, the order of mixing is fixed in this manner. However, the respective pixels of the character screen are associated with the depth values “Z” of the original sprite 304 or the original background screen 302, such that the selection of pixels are performed on the basis of these depth values “Z” and the depth values “Z” of the respective pixels of the bitmap screen 300. Accordingly, it is possible to interpose the layer of the bitmap screen 300 which is finally mixed between the layer of the sprite 304 and the layer of the background screen 302 which are first mixed together.

By way of example, as shown in FIG. 2B, a wind mill obj2 of the bitmap screen 300 can be placed between a balloon obj3 of the sprite 304 and a cloud obj1 of the background screen 302. In the case of the prior art technique, the wind mill obj2 of the bitmap screen 300 which is finally mixed can only be placed over or behind the mixed image of the balloon obj3 and the cloud obj1, but can not be placed between the balloon obj3 of the sprite 304 and the cloud obj1 of the background screen 302 which are first mixed together.

By the way, the processor 1000 can generate the bitmap screen as described above. This point will be explained with reference to drawings.

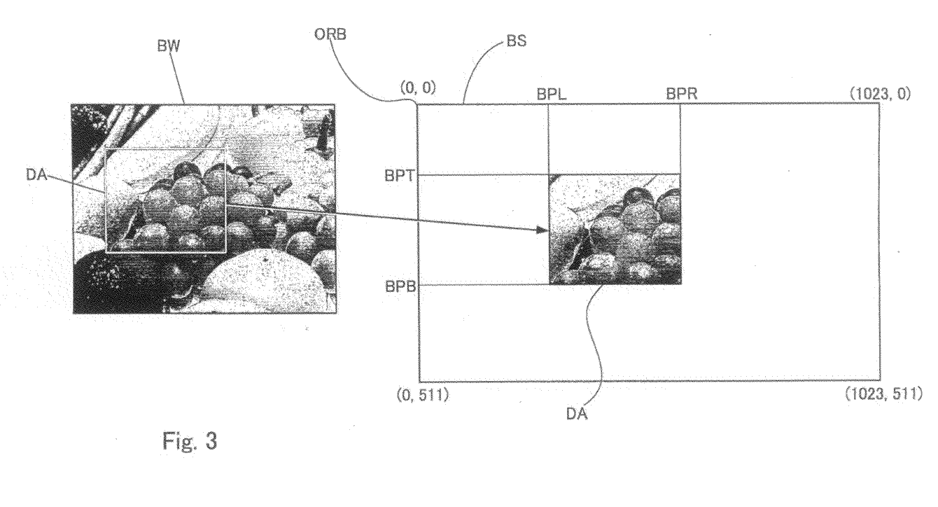

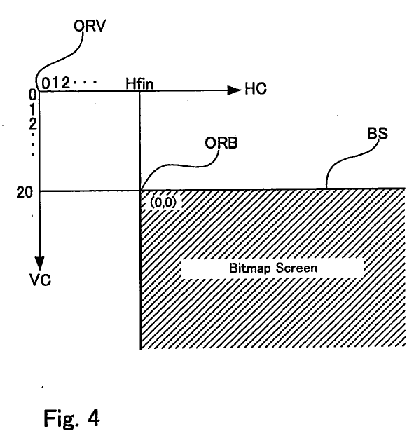

FIG. 3 is an explanatory view for showing a bitmap screen which is generated by the processor 1000 of FIG. 1. FIG. 3 shows an exemplary case where part of a bitmap image BW is displayed as a display area “DA”.

The coordinate system of the bitmap screen “BS” includes its origin ORB(0, 0) on the top left position and is provided to point a position by a horizontal coordinate of 10 bits (0 to 1023) and a vertical coordinate of 9 bits (0 to 511).

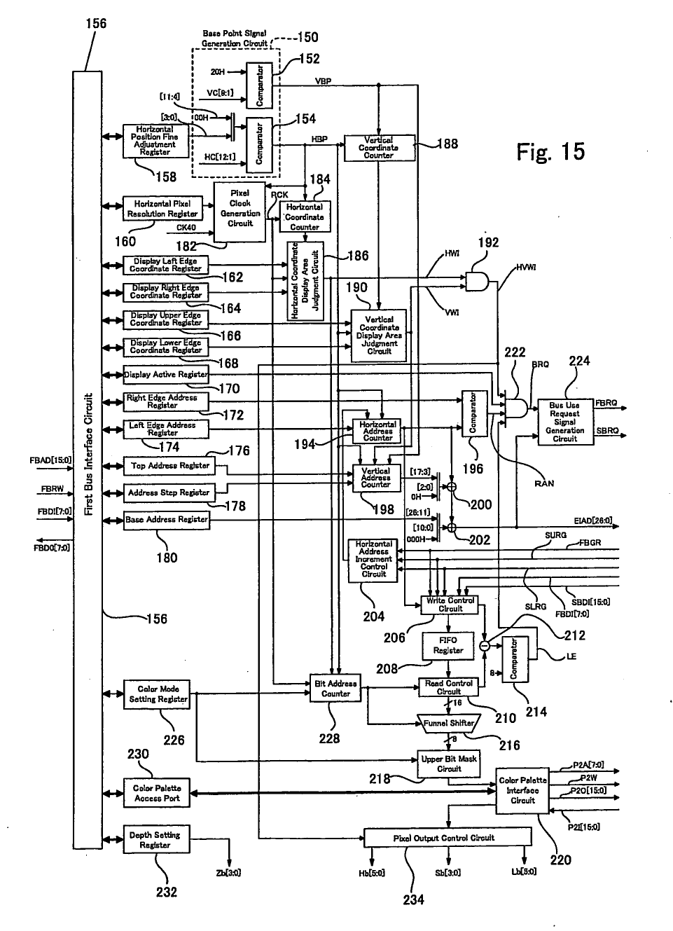

The CPU 1 sets values of control registers 166, 168, 162 and 164 of the graphics processor 3 (refer to FIG. 15 to be described below) respectively to the display upper edge coordinate “BPT”, the display lower edge coordinate “BPB”, the display left edge coordinate “BPL” and the display right edge coordinate “BPR” of the bitmap screen “BS”. In accordance with these settings, the display area “DA” is displayed on the display screen (television frame).

The coordinate system of the bitmap screen “BS” is independent from the coordinate system of the sprite and the background screen, i.e., the coordinate system of the character screen. Also, the coordinate system of the bitmap screen “BS” is based on a horizontal scan count “HC” (referred to herein as “the horizontal scan count HC” or “the horizontal scan count signal HC”), which is not offset to be described below, and a vertical scan count “VC” (referred to herein as “the vertical scan count VC” or “the vertical scan count signal VC”) which is not offset to be described below, and therefore the positional relationship between the origin of the coordinate system of the bitmap screen. “BS” and the display screen (television frame) is fixed. Nevertheless, the horizontal display position of the bitmap screen “BS” can be fine adjusted.

FIG. 4 is an explanatory view for showing the horizontal position fine adjustment of the bitmap screen “BS” in accordance with the present embodiment. As shown in FIG. 4, the CPU 1 can fine-adjust the horizontal position of the bitmap screen “BS” in a range from 0 to 15 by setting a control register 158 (refer to FIG. 15 to be described below) of the graphics processor 3 to a value “Hfin”.

The resolution of the bitmap screen “BS” will be explained. The CPU 1 can set the horizontal resolution of the bitmap screen “BS” by accessing a control register 160 (refer to FIG. 15 to be described below) of the graphics processor 3 to an arbitrary value in a range from two clocks per pixel (corresponding to 1024 pixels per horizontal line) to 16 clocks per pixel (corresponding to 128 pixels per horizontal line). An example is as follows. Incidentally, the horizontal resolution of the character screen (generated by a sprite(s) and a background screen(s)) is fixed to 8 clocks per pixel (corresponding to 256 pixels per horizontal line).

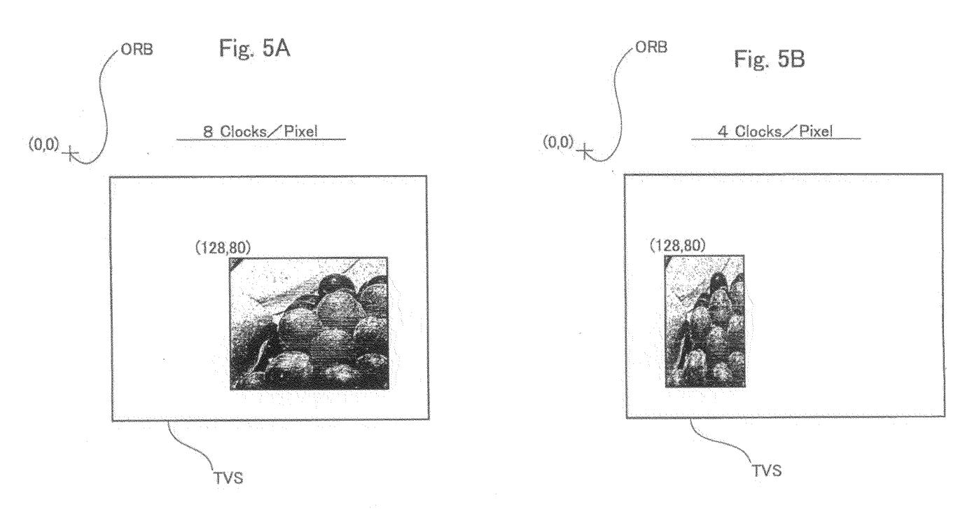

FIG. 5A is a view showing an example of the display image of the display area “DA” of FIG. 3 which is displayed at a resolution of 8 clocks per pixel; and FIG. 5B is a view showing an example of the display image of the display area “DA” which is displayed at a resolution of 4 clocks per pixel. As understood from FIG. 5A and FIG. 5B, when the horizontal resolution of the bitmap screen “BS” is doubled, the width of the display image is halved in the horizontal direction as displayed on the display screen “TVS” (television frame). While this is an example, it is possible to elongate or contract the display image in the horizontal direction by changing the horizontal resolution.

Next is an explanation of setting the addresses required for obtaining the data of the bitmap screen “BS”.

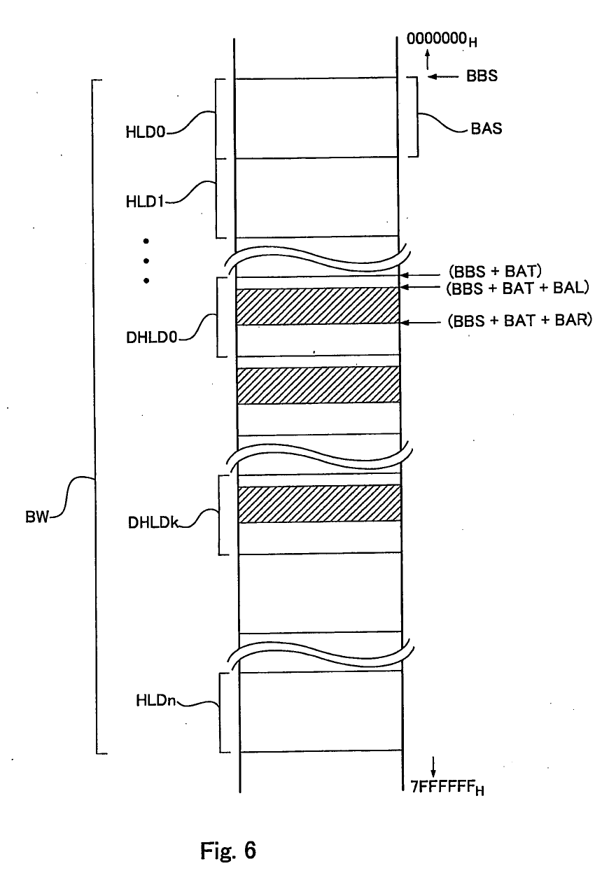

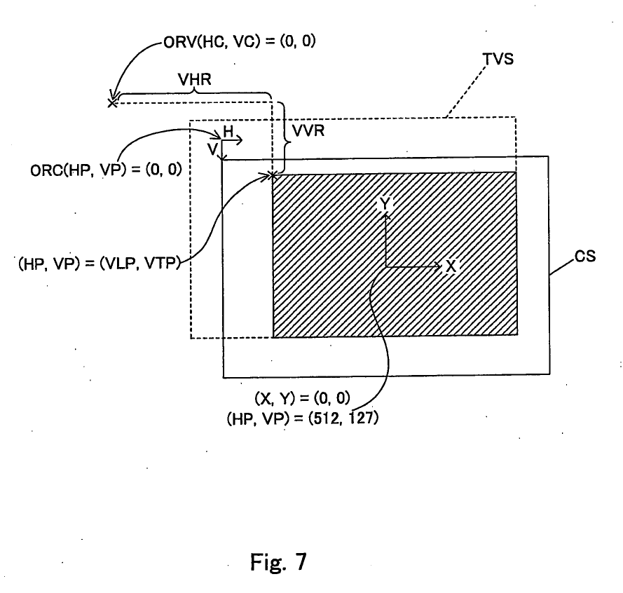

FIG. 6 is an explanatory view for showing the method of setting the addresses required for obtaining the bitmap data of the bitmap screen “BS” in accordance with the present embodiment. As shown in FIG. 6, it is assumed that the bitmap data “BW” of the bitmap screen “BS” consists of the data “HLD0” on the zeroth horizontal line, the data “HLD1” on the first horizontal line, . . . , and the data “HLDn” on the n-th horizontal line which is the last horizontal line. Also, the data “HLD0”, “HLD1”, . . . and “HLDn” includes display horizontal line data “DHLD0”, “DHLD1”, . . . and “DHLDk” to be displayed.

In this description, the term “data HLDN” (N=0 to n) is used respectively to generally represent the data “HLD0” on the zeroth horizontal line, the data “HLD1” on the first horizontal line, and the data “HLDn” on the n-th horizontal line which is the last horizontal line. Also, in this description, the term “data DHLDK” (K=0 to k) is used respectively to generally represent the display horizontal line data “DHLD0”, “DHLD1” . . . , and “DHLDk”.

The CPU 1 sets values of control registers 180, 176, 174, 172 and 178 respectively to a base address “BBS”, a top address “BAT”, a left edge address “BAL”, a right edge address “BAR”, and an address step “BAS”.

The base address “BBS” serves as the reference address from which the other set values can be located and is usually set to point to the head address of the whole bitmap data. In other words, the base address “BBS” points to the head address of the data “HLD0” on the zeroth horizontal line. The address step “BAS” is set to the number of bytes per horizontal line of the bitmap data “BW”.

The top address “BAT” is a displacement from the base address “BBS” and points to the head address of the display horizontal line data “DHLD0”. In other words, (the base address “BBS”+the top address “BAT”) points to the head address of the display horizontal line data “DHLD0”.

The left edge address “BAL” is the start address of the display data (hatched in the figure) in the display horizontal line data “DHLDK” as the displacement from the head address of the display horizontal line data “DHLDK”. In other words, in each display horizontal line data “DHLDK”, the start address of the display data is (the head address of the display horizontal line data “DHLDK”+the left edge address “BAL”).

The right edge address “BAR” is the last address of the display data (hatched in the figure) in the display horizontal line data “DHLDK” as the displacement from the head address of the display horizontal line data “DHLDK”. In other words, in each display horizontal line data “DHLDK”, the last address of the display data is (the head address of the display horizontal line data “DHLDK”+the right edge address “BAR”).

The head address of the display horizontal line data “DHLDK” is (the head address of the display horizontal line data “DHLD0”+the address step “BAS”×K).

As has been discussed above, the CPU 1 can cut and display only part of the bitmap image “BW” (which is a two-dimensional pixel array) stored in the memory MEM by setting the base address “BBS”, the top address “BAT”, the left edge address “BAL”, the right edge address “BAR”, and the address step BAS respectively to appropriate values (refer to FIG. 3).

By the way, the processor 1000 has the function of adjusting the display position of the character screen (comprising a sprite(s) and background screen(s)). This point will be explained with reference to drawings.

FIG. 7 is a view for explaining the function of adjusting the display position of the character screen by the processor 1000 of FIG. 1. As shown in FIG. 7, the CPU 1 can adjust the position of the character screen “CS” in relation to the display screen (television frame) “TVS”. More specifically speaking, the display position of the character screen “CS” can be adjusted by setting values of control registers 250, 242, 252, and 244 (refer to FIG. 17 to be described below) respectively to a horizontal count reference value “VHR”, a vertical count reference value “VVR”, a horizontal position left edge value “VLP” and a vertical position upper edge value “VTP”. This point will be explained in detail.

The coordinate system of the bitmap screen is based on the horizontal scan count “HC” with no offset and the vertical scan count “VC” with no offset as described above. The origin “ORV” of the horizontal scan count “HC” and the vertical scan count “VC” is located at an upper left position outside of the top left vertex of the display screen “TVS”. The vertical blanking interval and the horizontal blanking interval are included in the nondisplay periods between the top left vertex of the display screen “TVS” and the origin “ORV” of the horizontal scan count “HC” and the vertical scan count “VC”. The positive horizontal axis is extending in the horizontal right direction, and the positive vertical axis is extending in the vertical downward direction.

The horizontal scan count “HC” starts from the origin “ORV” and is incremented during scanning in the horizontal right direction. Then, the horizontal scan count “HC” is reset to “0” when reaching the horizontal cycle which is set in a control register (not shown in the figure) of the graphics processor 3. Also, the vertical scan count “VC” starts from the origin “ORV” and is incremented during scanning and reset to “0” when reaching the vertical cycle which is set in a control register (not shown in the figure).

On the other hand, the coordinate system of the character screen “CS” is based on a horizontal scan count “HP” (referred to herein as “the horizontal scan count HP” or “the horizontal scan count signal HP”), which is offset, and a vertical scan count “VP” (referred to herein as “the vertical scan count VP” or “the vertical scan count signal VP”) which is offset. The origin “ORC” of the horizontal scan count “HP” and the vertical scan count “VP” is located outside of the left edge of the character screen “CS”. The positive horizontal axis “H” is extending in the horizontal right direction, and the positive vertical axis “V” is extending in the vertical downward direction.

When the horizontal scan count “HC” reaches the horizontal count reference value “VHR”, the horizontal position left edge value “VLP” is loaded as the value of the horizontal scan count “HP”. Also, when the vertical scan count “VC” reaches the vertical count reference value “VVR”, the horizontal position upper edge value “VTP” is loaded as the value of the vertical scan count “VP”.

The horizontal scan count “HP” is incremented from the horizontal position left edge value “VLP” as the starting value during scanning in the horizontal right direction. The vertical scan count “VP” is sequentially incremented from the vertical position upper edge value “VTP” as the starting value during scanning.

As a result, of the character screen “CS”, the area which is hatched is displayed in the display screen “TVS”. In other words, it is possible to adjust the position of the character screen “CS” in relation to the display screen “TVS”.

Incidentally, “512” of the horizontal scan count “HP” is equivalent to “0” of the X coordinate of the character screen, while “127” of the vertical scan count “VP” is equivalent to “0” of the Y coordinate of the character screen.

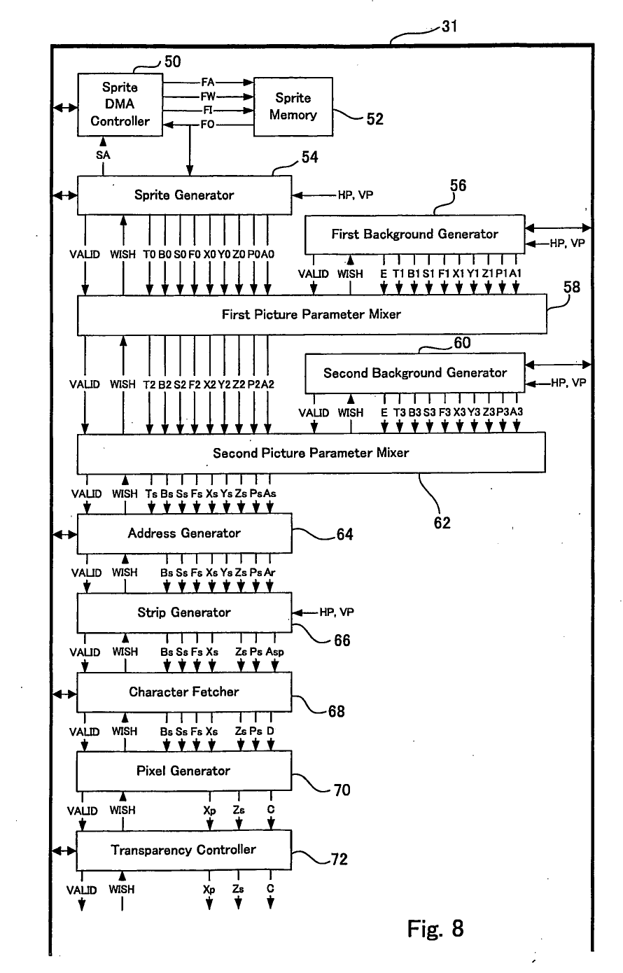

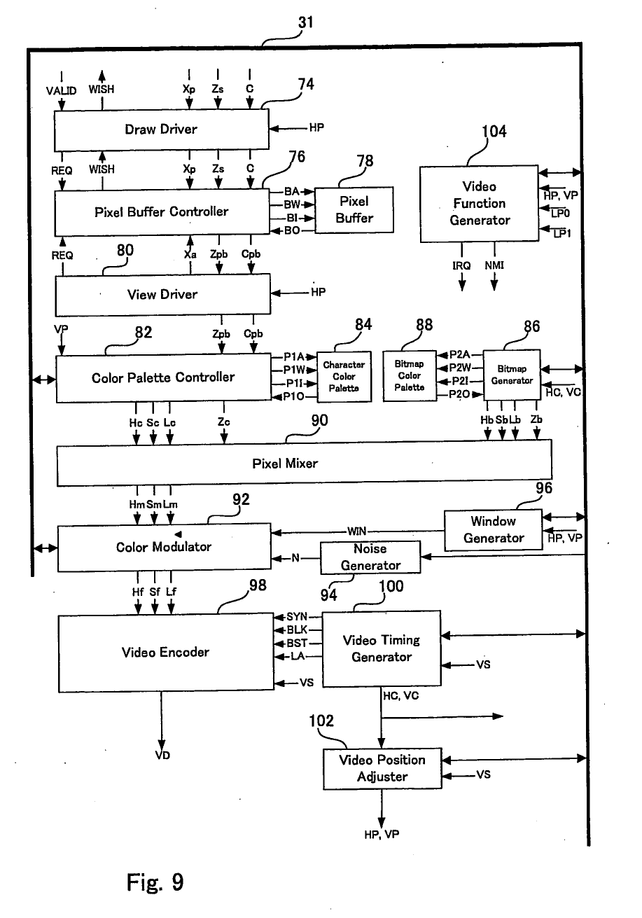

FIG. 8 is a block diagram showing the front part of the internal configuration of the graphics processor 3 of FIG. 1. FIG. 9 is a block diagram showing the subsequent part of the internal configuration of the graphics processor 3 of FIG. 1.

As shown in FIG. 8 and FIG. 9, the graphics processor 3 includes a sprite DMA controller 50, a sprite memory 52, a sprite generator 54, a first background generator 56, a first picture parameter mixer 58, a second background generator 60, a second picture parameter mixer 62, an address generator 64, a strip generator 66, a character fetcher 68, a pixel generator 70, a transparency controller 72, a draw driver 74, a pixel buffer controller 76, a pixel buffer 78, a view driver 80, a color palette controller 82, a character color palette 84, a bitmap generator 86, a bitmap color palette 88, a pixel mixer 90, a color modulator 92, a noise generator 94, a window generator 96, a video encoder 98, a video timing generator 100, a video position adjuster 102 and a video function generator 104.

The sprite memory 52 is a local memory which consists of 256 entries each of which consists of 56 bits, and one entry is used to store the respective parameters (referred to also as sprite parameters) of one sprite. In addition, the respective sprite parameters are stored respectively in predetermined positions in one entry.

The respective sprite parameters are the number of bits per pixel “B0[2:0]”, size information “S0[1:0]”, flip information “F0[1:0]”, horizontal position information “X0[8:0]”, vertical position information “Y0[7:0]”, depth value “Z0[3:0]”, palette information “P0[3:0]” and address information “A0[23:0]”.

The number of bits “B0” is the number of bits of each pixel of a character comprising a sprite (bit per pixel: color mode). The size information “S0” is the information indicative of the size of a character comprising a sprite which is set for example to “00” if the size of the character is 8 pixels (height)×8 pixels (width).

The flip information “F0” is the information indicative of the display inversion of a character comprising a sprite, and takes “00” for indicating that the character is not inverted, “10” for indicating that the character is inverted in the horizontal direction, “0” for indicating that the character is inverted in the vertical direction, and “11” for indicating that the character is inverted in the horizontal direction and in the vertical direction.

The horizontal position information “X0” is indicative of the horizontal coordinate of a sprite in the coordinate system of the character screen, while the vertical position information “Y0” is indicative of the vertical coordinate of the sprite in the coordinate system of the character screen (refer to FIG. 7).

The depth value “Z0” is the information indicative of the depth position in which the character comprising a sprite is located.

The palette information “P0” is the information for designating a palette entry. As will be described below, in accordance with the present embodiment, the character color palette 84 comprises a local memory used to store 256 colors. The palette information “P0” corresponds to the upper 4 bits of the 8-bit address pointing to one of the entries of the color palette 84. However, depending upon the color mode as selected, the lower bit(s) of the palette information “P0”, i.e., the lower one bit to the lower 4 bits, is overwritten by part of the color code of a pixel.

The address information “A0” is the information (head address information) indicative of the location of the memory MEM in which the pattern data of the character comprising a sprite (which is referred to also as character pattern data) is stored. The character pattern data contains the color codes of the respective pixels forming a character. In like manner, the character pattern data forming the first and second background screen contains the color codes of the respective pixels forming each constituent character.

The sprite DMA controller 50 serves to DMA transfer the respective sprite parameters stored in the main memory 17 to the sprite memory 52. The details are as follows.

The main memory 17 stores the sprite parameters of all the sprites to be displayed. For an example, seven data arrays are prepared in the main memory 17. While all sprite parameters (56 bits) of each sprite are divided into seven 8-bit blocks, the seven data arrays correspond respectively to the seven 8-bit blocks.

Each of the data arrays consists of array elements which are in the same number as all sprites to be displayed. Therefore, the each block of the sprite parameters is stored in the corresponding array element of the corresponding data array. In contrast to this, as has been discussed above, the respective sprite parameters of one sprite are stored in the predetermined locations of one entry of the sprite memory 52.

As thus described above, since the sprite parameters are stored in the main memory 17 and the sprite memory 52 in different fashions, the sprite DMA controller 50 performs DMA transmission from the main memory 17 to the sprite memory 52 after rearranging the sprite parameters stored in the main memory 17 into the arrangement suitable for the sprite memory 52.

Meanwhile, the sprite DMA controller 50 outputs an address “FA” and a read/write control signal “FW” to the sprite memory 52 for reading or writing data. In response to these signals, write data “FI” is written to the sprite memory 52, and read data “FO” is read out from the sprite memory 52.

Also, the sprite DMA controller 50 arbitrates the access to the sprite memory 52 among the write operation to the sprite memory 52 by DMA transfer, the access to the sprite memory 52 by the CPU 1, and the read operation from the sprite memory 52 by the sprite generator 54, for managing the access to the sprite memory 52 in an integrated fashion.

During the image displaying process, the sprite generator 54 repeatedly increments an address “SA” in order to successively read the data of each entry from the sprite memory 52, and outputs to the first picture parameter mixer 58 the respective sprite parameters “B0”, “S0”, “F0”, “X0”, “Y0”, “Z0”, “P0” and “A0” of the sprite (overlapping (or coming to overlap) the pixel buffer 78) located in the area where the image displaying process is performed in accordance with the horizontal scan count signal “HP” and the vertical scan count signal “VP”. In this description, by “the sprite overlapping the pixel buffer 78” it is meant that while the pixel buffer 78 is associated with a span of the horizontal coordinate to be described below, the sprite overlaps the span of the horizontal coordinate. However, with regards to the vertical position information “Y0”, the sprite generator 54 outputs only the lower 5 bits, i.e., “Y0[4:0]” rather than the full bits thereof. Meanwhile, the address “SA” is supplied to the sprite memory 52 as the address “FA” from the sprite DMA controller 50.

Also, the sprite generator 54 includes a register (not shown in the figure) which is accessible from the CPU 1 and used to store the format “T0[2:0]” of the address information of the sprites. The format “T0” of the address information is the information indicative of the addressing mode for use in fetching the character pattern data of a sprite. Attribute information as termed here is information containing the number of bits “B0”, the flip information “F0” and the palette information “P0”. This attribute information is stored in the sprite memory 52. The sprite generator 54 outputs the format “T0” of the address information to the first picture parameter mixer 58 as well as the above sprite parameters.

Incidentally, two handshake signals, i.e., a signal “VALID” and a signal “WISH” are used when data is transmitted from one stage to the subsequent stage. The signal “VALID” is transmitted from a data outputting unit to a data receiving unit and activated when data to be transmitted is valid. On the other hand, the signal “WISH” is transmitted from a data receiving unit to a data outputting unit and activated when the data receiving unit is ready to receive data. One byte data is transmitted during the period (one clock) when both the signals “VALID” and “WISH” are activated.

The first background generator 56 is provided with registers (not shown in the figure) which are accessible by the CPU 1 and used to store pointers “L1”, “H1” and “U1” pointing to arrays in the main memory 17 storing the information of the first background screen. The registers store the information of the first background screen including the number of bits per pixel “B1[2:0]”, size information “S1[1:0]”, flip information “F1[1:0]”, horizontal position information “TX1[7:0]”, vertical position information “TY1[7:0]”, depth value “Z1[3:0]”, palette information “P1[3:0]”, the format “T1[2:0]” of the address information and the location “W1” of the attribute information.

The arrays in the main memory 17 pointed to by the read pointers “L1”, “H1” and “U1” are used respectively to store address information “A1” pointing to the location of the character pattern data in the memory MEM used for the first background screen, and also store two attribute information items, i.e., the palette information “P1” and the depth value “Z1”. Valid data size (1 to 3 bytes) of this address information “A1” is determined in accordance with the format “T1” of the address information while this attribute information is made valid when the location “W1” of the attribute information designates the corresponding array.

In this case, the number of bits “B1”, the size information “S1”, the flip information “F1”, the depth value “Z1”, palette information “P1” and the format “T1” of the address information are associated with the character forming the first background screen, but correspond respectively to the number of bits “B0”, the size information “S0”, the flip information “F0”, the depth value “Z0”, palette information “P0”, and the format “T0” of the address information of the character forming the above sprite.

In addition, the first background generator 56 reads the information (that is, the array elements, in other words, the address information “A1”, the depth value “Z1” and the palette information “P1”) of the character (overlapping (or coming to overlap) the pixel buffer 78) located in the area where the image displaying process is performed, through the first bus 31 from the main memory 17 in accordance with the horizontal scan count signal “HP” and the vertical scan count signal “VP”, and outputs them to the first picture parameter mixer 58, while the first background generator 56 also outputs the other information of the character (the number of bits “B1”, the size information “S1”, the flip information “F1”, the horizontal position information “X1”, the vertical position information “Y1”, the depth value “Z1”, the palette information “P1”, the format “T1” of the address information) to the first picture parameter mixer 58. However, the location “W1” of the attribute information is not used in the subsequent stages and therefore not transmitted. In this case, if the location “W1” of the attribute information is “0”, the depth value “Z1” and the palette information “P1” are output from the registers of the first background generator 56, and if the location “W1” of the attribute information is “1”, the depth value “Z1” and the palette information “P1” are read from the main memory 17 and output to the first picture parameter mixer 58. Also, with regards to the horizontal position information “X1” and the vertical position information “Y1”, the horizontal position information “X1[8:0]” and the vertical position information “Y1[4:0]” of each character are calculated on the basis of the horizontal position information “TX1” and the vertical position information “TY1” of the background screen, and output to the first picture parameter mixer 58.

In addition, the first background generator 56 outputs the signal “VALID” and an emergency signal “E” to the first picture parameter mixer 58, and receives the signal “WISH” from the first picture parameter mixer 58. The emergency signal “E” is the signal which demands reception of data by the subsequent stage, and is activated when the data as output is not transferred to the subsequent stage for a certain time.

Specifically speaking, when the position information of the output data (the horizontal position information “X1” and the vertical position information “Y1”) is substantially delayed from the position information indicated by the horizontal scan count signal “HP” and the vertical scan count signal “VP”, the first background generator 56 detects a wide positional difference therebetween and activates the emergency signal “E”.

The first picture parameter mixer 58 outputs to the second picture parameter mixer 62 signals “T2”, “B2”, “S2”, “F2”, “X2”, “Y2”, “Z2”, “P2” and “A2” by selecting and unifying the signals “T0”, “B0”, “S0”, “F0”, “X0”, “Y0”, “Z0”, “P0” and “A0” for defining the sprite as output from the sprite generator 54 and the signals “T1”, “B1”, “S1”, “F1”, “X1”, “Y1”, “Z1”, “P1” and “A1” for defining the first background screen as output from the first background generator 56 in accordance with the following rules.

In this case, the first picture parameter mixer 58 preferentially selects the signals “T0”, “B0”, “S0”, “F0”, “X0”, “Y0”, “Z0”, “P0” and “A0” for defining the sprite unless otherwise required as specified below. Namely, the first picture parameter mixer 58 selects the signals “T1”, “B1”, “S1”, “F1”, “X1”, “Y1”, “Z1”, “P1” and “A1” for defining the first background screen when the emergency signal “E” is activated. Needless to say, even if the emergency signal “E” is not activated, the signals “T1”, “B1”, “S1”, “F1”, “X1”, “Y1”, “Z1”, “P1” and “A1” for defining the first background screen is selected when the signals “T0”, “B0”, “S0”, “F0”, “X0”, “Y0”, “Z0”, “P0” and “A0” for defining the sprite are not input.

Also, the first picture parameter mixer 58 outputs the signal “VALID” to the second picture parameter mixer 62 while the signal “WISH” is input from the second picture parameter mixer 62 to the first picture parameter mixer 58.

The second background generator 60 is provided with registers (not shown in the figure) which are accessible by the CPU 1 and used to store pointers “L2”, “H2” and “U2” pointing to arrays in the main memory 17 in which the information of the second background screen is stored. The registers store the information relating to the second background screen, i.e., the number of bits per pixel “B3[2:0]”, size information “S3[1:0]”, flip information “F3[1:0]”, horizontal position information “TX3[7:0]”, vertical position information “TY3[7:0]”, depth value “Z3[3:0]”, palette information “P3[3:0]”, the format “T3[2:0]” of the address information and the location “W3” of the attribute information.

The arrays in the main memory 17 pointed to by the read pointers “L2”, “H2” and “U2” are used respectively to store address information “A3” pointing to the location of the character pattern data in the memory MEM used for the second background screen, and two attribute information items, i.e., the palette information “P3” and the depth value “z3”. Valid data size (1 to 3 bytes) of this address information “A3” is determined in accordance with the format “T3” of the address information while this attribute information is made valid when the location “W3” of the attribute information designates the corresponding array.

In this case, the number of bits “B3”, the size information “S3”, the flip information “F3”, the depth value “Z3”, the palette information “P3”, and the format “T3” of the address information are associated with the character forming the second background screen, but correspond respectively to the number of bits “B1”, the size information “S1”, the flip information “F1”, the depth value “Z1”, palette information “P1”, and the format “T1” of the address information of the character forming the second background screen.

In addition, the second background generator 60 reads the information (that is, the array elements, in other words, the address information “A3”, the depth value “Z3” and the palette information “P3”) of the character (overlapping (or coming to overlap) the pixel buffer 78) located in the area where the image displaying process is performed, through the first bus 31 from the main memory 17 in accordance with the horizontal scan count signal “HP” and the vertical scan count signal “VP”, and outputs them to the second picture parameter mixer 62, while the second background generator 60 also outputs the other information of the character (the number of bits “B3”, the size information “S3”, the flip information “F3”, the horizontal position information “X3”, the vertical position information “Y3”, the depth value “Z3”, the palette information “P3”, the format “T3” of the address information) to the second picture parameter mixer 62. However, the location “W3” of the attribute information is not used in the subsequent stages and therefore not transmitted. In this case, if the location “W3” of the attribute information is “0”, the depth value “Z3” and the palette information “P3” are output from the registers of the second background generator 60, and if the location “W3” of the attribute information is “1”, the depth value “Z3” and the palette information “P3” are read from the main memory 17 and output to the second picture parameter mixer 62. Also, with regards to the horizontal position information “X3” and the vertical position information “Y3”, the horizontal position information “X3[8:0]” and the vertical position information “Y3[4:0]” of each character are calculated on the basis of the horizontal position information “TX3” and the vertical position information “TY3” of the background screen, and output to the second picture parameter mixer 62.

In addition, the second background generator 60 outputs the signal “VALID” and the emergency signal “E” to the second picture parameter mixer 62, and receives the signal “WISH” from the second picture parameter mixer 62.

The second picture parameter mixer 62 outputs to the address generator 64 signals “Ts”, “Bs”, “Ss”, “Fs”, “Xs”, “Ys”, “Zs”, “Ps” and “As” by selecting and unifying the signals “T2”, “B2”, “S2”, “F2”, “X2”, “Y2”, “Z2”, “P2” and “A2” for defining the sprite and/or the first background screen as output from the first picture parameter mixer 58 and the signals “T3”, “B3”, “S3”, “F3”, “X3”, “Y3”, “Z3”, “P3” and “A3” for defining the second background screen as output from the second background generator 60 in accordance with the following rules.

In this case, the second picture parameter mixer 62 preferentially selects the signals “T2”, “B2”, “S2”, “F2”, “X2”, “Y2”, “Z2” “P2” and “A2” as output from the first picture parameter mixer 58 unless otherwise required as specified below. Namely, the second picture parameter mixer 62 selects the signals “T3”, “B3”, “S3”, “F3”, “X3”, “Y3”, “Z3”, “P3” and “A3” for defining the second background screen when the emergency signal “E” is activated. Needless to say, even if the emergency signal “E” is not activated, the signals “T3”, “B3”, “S3”, “F3”, “X3”, “Y3”, “Z3”, “P3” and “A3” for defining the second background screen is selected when the signals “T2”, “B2”, “S2”, “F2”, “X2”, “Y2”, “Z2”, “P2” and “A2” are not input from the first picture parameter mixer 58.

Also, the second picture parameter mixer 62 outputs the signal “VALID” to the address generator 64 while the signal “WISH” is input from the address generator 64.

The address generator 64 is a circuit for converting address information “As” into a real address “Ar” of 27 bits in accordance with the format “Ts” of the address information output from the second picture parameter mixer 62. The address generator 64 is provided with 16 segment registers each of which consists of 16 bits (not shown in the figure) which are accessible by the CPU 1 and used to store a base address and segment addresses for use in converting the address information “As”.

In accordance with the present embodiment, there are eight types of the addressing modes indicated by the format “Ts” of the address information. Namely, there are an 8-bit character number mode, a 16-bit character number mode, a 16-bit aligned address pointer mode, a 16-bit address pointer mode, a 24-bit address pointer mode, a 16-bit extended character number mode, a 16-bit extended address pointer mode and a 24-bit aligned address pointer mode.

The 8-bit character number mode is used to select a character by an 8-bit number “As”. The 16-bit character number mode is used to select a character by a 16-bit number “As”. In these modes, on the basis of the base address (256-byte alignment) stored in the segment register addressed by “0”, a real address “Ar” is calculated from the size of one character corresponding to the number of bits “Bs” and the size information “Ss” output from the second picture parameter mixer 56. Specifically speaking, a real address “Ar” is calculated as (base address)+(the character number indicated by the address information “As”)×(the number of bits per pixel indicated by the number “Bs”)×(the number of pixels per character indicated by the size information “Ss”)/8. Incidentally, the division by “8” is performed because the real address “Ar” is a byte address.

In the 16-bit aligned address pointer mode, a character is selected by a 16-bit address pointer “As” with alignment. More specifically speaking, a 27-bit real address “Ar” is generated as the sum of the segment address (256-byte alignment) stored in the segment register pointed to by the upper 3 bits of the 16-bit aligned address pointer “As”, and the lower 13 bits (8-byte alignment) of the 16-bit aligned address pointer “As”, with additional upper three bits respectively set to “0”.

In the 16-bit address pointer mode, a character is selected by a 16-bit address pointer “As”. More specifically speaking, a 27-bit real address “Ar” is generated as the sum of the segment address (256-byte alignment) stored in the segment register pointed to by the upper 4 bits of the 16-bit address pointer “As”, and the lower 12 bits of the 16-bit address pointer “As”, with additional upper three bits respectively set to “0”.

In the 24-bit address pointer mode, a character is selected by a 24-bit address pointer “As”. More specifically speaking, the 24-bit address pointer “As” can be used simply as a 27-bit real address “Ar” with additional upper three bits respectively set to “0”.

The 16-bit extended character number mode is an extended mode of the 16-bit character number mode. In this mode, on the basis of the 27-bit base address (2K-byte alignment) stored in the segment register addressed by “0”, a real address “Ar” is calculated from the size of one character corresponding to the number of bits “Bs” and the size information “Ss” output from the second picture parameter mixer 56. The actual calculation is the same as that used in the 16-bit character number mode.

The 16-bit extended address pointer mode is an extended mode of the 16-bit address pointer mode. More specifically speaking, a real address “Ar” is generated as the sum of the 27-bit base address (2K-byte alignment) stored in the segment register pointed to by the upper 4 bits of the 16-bit address pointer “As”, and the lower 12 bits of the 16-bit address pointer “As”.

In the 24-bit aligned address pointer mode, a 27-bit real address “Ar” is generated by concatenating three zeros as the lower three bits to the 24-bit address pointer “As” as the upper 24 bits of the 27-bit real address (B byte alignment).

As has been discussed above, the address generator 64 converts the address information “As” into a real address “Ar” (referred to herein as the address information “Ar”), and outputs the address information “Ar” to the strip generator 66 together with the other signal “Bs”, “Ss”, “Fs”, “Xs”, “Ys”, “Zs” and “Ps”. However, the format “Ts” of the address information is not used in the subsequent stages and therefore not transmitted.

On the other hand, the address generator 64 supplies the signal “VALID” to the strip generator 66 while the signal “WISH” is input from the strip generator 66 to the address generator 64.

The strip generator 66 selects the character (overlapping (or coming to overlap) the pixel buffer 78) located in the area where the image displaying process is performed in accordance with the horizontal scan count signal “HP” and the vertical scan count signal “VP”.

Then, the strip generator 66 extracts a one-dimensional array (referred to also as strip) forming a horizontal line to be drawn from the character pattern data (a two-dimensional array) as selected. For example, if a character consists of 16 pixels×16 pixels, a strip consists of a horizontal line of 16 pixels. More specific description is as follows.

The strip generator 66 determines a strip to be extracted on the basis of the vertical position information “Ys”, the flip information “Fs” indicative of inversion in the vertical direction, and the vertical scan count signal “VP”.

Then, the strip generator 66 calculates the address information (start address) “Asp” of the strip to be extracted as determined on the basis of the address information (start address) “As” of character pattern data, the number of bits “Bs”, and horizontal size corresponding to the size information “Ss” of the character. This is the extraction of a strip. The extraction of a strip in this case is therefore not the extraction of color codes of the strip as determined from the character pattern data.

The strip generator 66 outputs the calculated address information “Asp” to the character fetcher 68 together with the other signal “Bs”, “Ss”, “Fs”, “Xs”, “Zs” and “Ps”. However, a part of the flip information “Fs” indicative of inversion in the vertical direction and the vertical position information “Ys” are not used in the subsequent stages and therefore not transmitted.

In addition, the strip generator 66 outputs the signal “VALID” to the character fetcher 68 while the signal “WISH” is input from the character fetcher 68 to the strip generator 66.

The character fetcher 68 converts a character, which is transmitted as the address information “Asp”, into color codes. More specifically speaking, the character fetcher 68 reads data “D” (that is, color codes of the respective pixels forming a strip) with the amount of the data as calculated from the number of bits per pixel “Bs” and the horizontal size indicated by the size information “Ss” from the location of the memory MEM pointed to by the address information “Asp” in bytes, and sequentially outputs the data “D” to the pixel generator 70 on a byte-by-byte basis in little endian order. In the following explanation, the data “D” is referred to as the strip pattern data “D”.

The character fetcher 68 also outputs other signal “Bs”, “Ss”, “Fs”, “Xs”, “Zs” and “Ps” to the pixel generator 70 together with the strip pattern data “D”. In addition, the character fetcher 68 outputs the signal “VALID” to the pixel generator 70 while the signal “WISH” is input from the pixel generator 70 to the character fetcher 68.

The pixel generator 70 arranges byte data (part or all of the strip pattern data “D”), as sequentially received, in little endian order, and extracts data (the color code of one pixel) of the number of bits (M bits per pixel: M=1 to 8) indicated by the number of bits per pixel “Bs” from the lower bits of the strip pattern data “D”. Then, the pixel generator 70 generates an 8-bit color code “C” by combining the color code of one pixel as extracted with the palette information “Ps”. This combination is performed as follows. Namely, the palette information “Ps” is used as the upper 4 bits of the 8-bit color code, and then the color code of one pixel as extracted is used as the lower M bits. The remaining bits are filled with “0”. If the number of bits M is no smaller than 5, the lower bit(s) of the palette information “Ps” is overwritten by the color code of one pixel as extracted.

As has been discussed above, the pixel generator 70 generates a color code “C” for each pixel (referred to hereinbelow as a pixel color code “C”) on the basis of the strip pattern data “D” given in bytes. This is because the strip pattern data “D” is given in bytes, while in many cases the number of bits per pixel “Bs” is not eight bits (1 byte).

Also, the pixel generator 70 calculates horizontal position information “Xp” for each pixel on the basis of the horizontal position information “Xs” of a character. In this case, if the flip information “Fs” indicates inversion in the horizontal direction, the horizontal position information “Xp” for each pixel is calculated by decrement from the position advanced by the horizontal size indicated by the size information “Ss” in the reverse direction.

The pixel generator 70 outputs the pixel color code “C” and the horizontal position information “Xp”, obtained as described above, together with the depth value “Zs” to the transparency controller 72. However, the bit number “Bs”, the size information “Ss”, the flip information “Fs” and the palette information “Ps” are not used in the subsequent stages and therefore not transmitted. Also, the pixel generator 70 outputs the signal “VALID” to the transparency controller 72 while the signal “WISH” is input from the transparency controller 72 to the pixel generator 70.

The transparency controller 72 is provided with a transparency control memory (not shown in the figure) consisting of 16 entries each of which consists of 5 bits which can be indirectly accessed by the CPU 1. The character color palette 84 to be described below is composed of a local memory which includes 256 entries each of which consists of 16 bits, which can be grouped into 16 blocks each of which is 16 entries so that a maximum of one transparent color can be provided for each block. Each entry of the transparency control memory is associated with the corresponding block of the character color palette 84. When the CPU 1 writes color data to an entry of the character color palette 84 and if the color data indicates a transparent color, the entry of the transparency control memory corresponding to the block including the entry is used to store a 4-bit value indicative of which entry in the block saves the transparent color and set a one-bit value (referred to herein as a transparency valid bit) to “1” indicative of the transparency. In this case, if the transparent color in the entry of the character color palette 84 is overwritten by a non-transparent color, the corresponding transparency valid bit is cleared to “0” such that the entry is associated with the non-transparent color.

The transparency controller 72 accesses the transparency control memory by the upper 4 bits of the pixel color code “C” input from the pixel generator 70 (i.e., the palette information “Ps”), and if the transparency valid bit of the accessed entry is “1” and if the remaining 4 bits of the accessed entry matches the lower 4 bits of the pixel color code “C”, then the transparency controller 72 judges that the pixel is transparent.

The transparency controller 72 outputs to the draw driver 74 the information of a pixel, which is judged non-transparent, i.e., (the horizontal position information “Xp”, the depth value “Zs” and the pixel color code “C”), and does not output but does discard here the information of a pixel, which is judged transparent. In addition, the transparency controller 72 outputs the signal “VALID” to the draw driver 74, while the signal “WISH” is input from the draw driver 74 to the transparency controller 72.

The draw driver 74 judges whether or not the pixel of which the display position is indicated by the horizontal position information “Xp” overlaps the pixel buffer 78 on the basis of the horizontal position information “Xp” and the horizontal scan count signal “HP”. And if the pixel overlaps the pixel buffer 78, the draw driver 74 instructs the pixel buffer controller 76 to write the depth value “Zs” and the pixel color code “C” of the pixel to the pixel buffer 78 (i.e., by issuing a request for drawing). Since the horizontal scan count signal “HP” may be incremented by one after issuing a request for drawing and before accepting the request for drawing, the draw driver 74 makes the judgment in the area of the pixel buffer 78 narrowed by one pixel.

Namely, the draw driver 74 outputs a drawing request signal “REQ” to the pixel buffer controller 76 if it is judged that the pixel overlaps the pixel buffer 78, and outputs the horizontal position information “Xp”, the depth value “Zs” and the pixel color code “C” to the pixel buffer controller 76 when the signal “WISH” is input from the pixel buffer controller 76.

The pixel buffer controller 76 performs arbitration of a request for drawing issued by the draw driver 74 and a request for reading issued by the view driver 80. In this case, the request for reading issued by the view driver 80 is given priority. As a result of arbitration, the pixel buffer controller 76 performs the required process as accepted. In this case, the pixel buffer controller 76 generates a read/write signal “BW” to drive the pixel buffer 78, and reads read data “BO” from the location pointed to by address information “BA” or writes write data “BI” to the location pointed to by address information “BA”. The details of each request (drawing or reading) are as follows.

When accepting the drawing request of the draw driver 74, the pixel buffer controller 76 compares the depth value “Zs” input from the draw driver 74 with the depth value “Zpb” included in the read data “BO” (the depth value “Zpb” and the pixel color code “Cpb”) as read from the pixel buffer 78. Then, in accordance with the result of comparison, the pixel buffer controller 76 determines the data “BI” to be written to the pixel buffer 78, i.e., which is to be written, the data “BO” as read (the depth value “Zpb” and the pixel color code “Cpb”) or the data as input (the depth value “Zs” and the pixel color code “C”). In this case, the data containing the larger depth value is written to the pixel buffer 78 as the write data “BI”. Incidentally, the address information “BA” to be input to the pixel buffer 78 is generated on the basis of the horizontal position information “Xp”.

On the other hand, when the read request of the view driver 80 is accepted, the pixel buffer controller 76 outputs the read data “BO” (the depth value “Zpb” and the pixel color code “Cpb”) read from the pixel buffer 78 to the view driver 80. Incidentally, after outputting the read data “BO” to the view driver 80, the read location of the pixel buffer 78 is cleared with write data which is fixed to “0” (corresponding to the depth value indicative of the deepest position). The address information “BA” to be input to the pixel buffer 78 is address information “Xa” input from the view driver 80.

The pixel buffer 78 comprises a depth buffer and a code buffer (not shown in the figure), which are composed respectively of 128 entries each of which consists of 4 bits per pixel and 128 entries each of which consists of 8 bits per pixel. In this description, the entry for one pixel of the pixel buffer 78 is referred to as a pixel buffer unit (consisting of 4 bits for the depth value “Zpb” and 8 bits for the pixel color code “Cpb”, totaling to 12 bits).

The pixel buffer 78 sequentially stores the depth value “Zpb” and the pixel color code “Cpb” for each pixel in order that the tail location of the pixel buffer 78 is the location of the pixel buffer unit corresponding to the scan position (i.e., the read position of the view driver 80), and the top location of the pixel buffer 78 is the location of the pixel buffer unit corresponding to the position as advanced from the scan position by the capacity of the pixel buffer 78. When the scan position is shifted, the pixel buffer unit at the tail is then used as the pixel buffer unit at the top in order to cyclically use the pixel buffer units.

The view driver 80 issues a request to the pixel buffer controller 76 for reading data from the pixel buffer 78 on the basis of the horizontal scan count signal “HP”. This read request is issued by outputting, to the pixel buffer controller 76, the address information “Xa” generated on the basis of the horizontal scan count signal “HP” together with the signal “REQ”. The read request of the view driver 80 is given priority by the pixel buffer controller 76 so that there is no wait signal for the read request.

In addition, the view driver 80 outputs the depth value “Zpb” and the pixel color code “Cpb” to the color palette controller 82.

The character color palette 84 is a local memory containing 256 entries each of which consists 16 bits, while each entry comprises a hue of 6 bits, a color saturation of 4 bits and a brightness of 6 bits. In other words, one entry represents one color by 16 bits.

A hue can take an integer from 0 to 47, and a color saturation can take an integer from 0 to 15, and a brightness can take an integer from 0 to 47. A transparent color is designated by setting the hue to a value from 48 to 63.

The color palette controller 82 accesses the character color palette 84 with an address “P1A” which is the pixel color code “Cpb” input from the view driver 80, converts the pixel color code “Cpb” into a hue “Hc”, a color saturation “Sc” and a brightness “Lc”, and outputs them to the pixel mixer 90 together with the depth value “Zs” (referred to hereinbelow as the depth value “Zc”). In accordance with the present embodiment, the rate of outputting these values is eight clocks per pixel. The color palette controller 82 will be described below in detail.

Incidentally, in this description, the hue “Hc”, the color saturation “Sc”, the brightness “Lc” and the depth value “Zc” are referred also as “pixel data PDC”.

The two-dimensional array consisting of the pixel data “PDC” as output from the color palette controller 82 is the character screen (the sprite+the background screen).

The bitmap generator 86, which is related to one of the characteristic features of the present invention, reads bitmap data which is stored in the memory MEM on the basis of the horizontal scan count signal “HC” and the vertical scan count signal “VC” generated by the video timing generator 100 to be described below, generate pixel data “PDB” of the bitmap screen (which is data comprising a hue “Hb”, a color saturation “Sb”, a brightness “Lb” and a depth value “Zb”), and outputs the pixel data “PDB” to the pixel mixer 90 at the output rate corresponding to the horizontal resolution of the bitmap screen. Incidentally, as has been discussed above, the horizontal resolution of the bitmap screen is programmable such that the resolutions of up to 1024 pixels per horizontal line are supported. The bitmap generator 86 will be described below in detail.

The bitmap color palette 88 is designed in the same configuration as the character color palette 84. However, a transparent color is designated by setting the hue to a value of “47”, the color saturation to a value of “0” and the brightness to a value of “0” respectively.

The pixel mixer 90, which is related to one of the characteristic features of the present invention, mixes the pixel data “PDC” of the character screen as input from the color palette controller 82 and the pixel data “PDB” of the bitmap screen as input from the bitmap generator 86. The pixel mixer 90 determines pixel data to be output (a data item comprising a hue, a color saturation and a brightness) on the basis of the depth values “Zc” and “Zb” indicative of depth positions on the display screen (television frame). However, even in the case where the depth value of a data item is indicative of the foreground position, if the hue is indicative of a transparent color, the other pixel data item is selected. The pixel mixer 90 will be described below in detail.

The hue, color saturation and brightness of a pixel data item as output from the pixel mixer 90 are referred to respectively as the hue “Hm”, color saturation “Sm” and brightness “Lm”.

The window generator 96 is a circuit which serves to make special effects on the character screen mixed with the bitmap screen and divide it into a masked area and non-masked area. The special effects can be performed in the masked area by the use of the color modulator 92 to be described below. This window generator 96 is provided with registers which are accessible by the CPU 1 and used to set the coordinates of the start point of the mask, the coordinates of the end point of the mask and the logic of the left edge of the screen respectively in one horizontal line. The logic of the left edge of the character screen is a logic indicative of the state at the left edge, i.e., a logic indicative of whether or not the left edge is masked.

The window generator 96 starts outputting the signal “WIN” in accordance with the logic as set of the left edge of the screen, asserts the signal “WIN” when the horizontal scan count signal “HP” reaches the start point of the mask, and negates the signal “WIN” when the horizontal scan count signal “HP” reaches the end point of the mask. In addition, every time the signal “WIN” reaches the start point or end point of the mask, an interrupt is issued to the CPU 1 which then can change the start point and/or end point of the mask in a successive manner. By this configuration, it is possible to provide the mask area of the character screen mixed with the bitmap screen in a variety of profiles.

The noise generator 94 generates noise to produce one of the visual color effects which can be made by the color modulator 92. More specifically, the noise generator 94 is a digital pseudo-random number sequence generator using an M-sequence (polynomial counter), and outputs the lower three bits of the M-sequence as a noise component “N[2:0]”. Incidentally, the noise generator 94 is reset by the reset signal “LPW” in order to prevent a cyclic operation in an abnormal loop.

The color modulator 92 is a circuit which serves to give a variety of visual effects to the color (the hue “Hm”, the color saturation “Sm” and the brightness “Lm”) input thereto. The color modulator 92 is activated when the signal “WIN” is asserted, and inactivated when the signal “WIN” is negated.

The color modulator 92 is provided with a variety of registers and flags which are accessible by the CPU 1 and used to set visual effects. There are four effects which are available as follows.

When the first effect is used, the respective components of color, i.e., the hue, the color saturation and the brightness are individually fixed. These components can be set respectively in the registers (not shown in the figure) corresponding thereto. The value loaded to each of these registers is effective respectively if a flag (not shown in the figure) provided corresponding to the register is set to ‘1’. This flag is provided individually for each component such that it can be determined for each component whether or not the fixed value is used.

When the second effect is used, the value of the brightness “Lm” and the value of the color saturation “Sm” can respectively be halved by setting ‘1’ to flags (not shown in the figure) provided for halftone effect corresponding respectively to the components.

When the third effect is used, negative/positive inversion can be performed. More specifically, a value of “24” is added to the hue “Hm” and then, if the result exceeds “47”, a value of “48” is subtracted from the hue “Hm” in order to wrap around to “0”, while the brightness “Lm” is subtracted from a value of “47”. As a result, the bright and dark are inverted.

When the fourth effect is used, an appropriate degree of noise can be applied to the brightness. More specifically, the lower three bits of the brightness “Lm” and the noise component “N[2:0]” output from the noise generator 94 are bitwise XORed together. Corresponding to the respective three bits, there are flags (not shown in the figure) which indicate whether or not the XOR operation is performed, such that it is possible to adjust the noise amount as applied by these flags.

In this description, the hue “Hm”, the color saturation “Sm” and the brightness “Lm” are referred to respectively as the hue “Hf”, the color saturation “Sf” and the brightness “Lf” after application of visual effects by the use of the color modulator 92. However, since these visual effects are not necessarily applied, the hue “Hm”, the color saturation “Sm” and the brightness “Lm” which are output from the color modulator 92 as they are without visual effects are referred to also as the hue “Hf”, the color saturation “Sf” and the brightness “Lf”.

The video encoder 98 converts color information (the hue “Hf”, the color saturation “Sf” and the brightness “Lf”) input from the color modulator 92 and timing information (a composite synchronization signal “SYN”, a composite blanking signal “BLK”, a burst flag signal “BST”, an alternating line signal “LA” and so forth) input from the video timing generator 100 into a composite video signal “VD” in accordance with a signal “VS” as input. The signal “VS” is a signal indicative of a television system (NTSC/PAL). The alternating line signal “LA” is used when PAL is selected as the television system by the signal “VS”. The details of the video encoder 98 are as follows.

The video encoder 98 comprises a 48-base counter of 6 bits which returns to zero after it counts to “47”, and this counter is incremented by “4” in the case of NTSC and by “5” in the case of PAL in synchronization with the clock signal “CK40” of 43 MHz. Accordingly, the counter wraps around once every 12 clocks in the case of NTSC and every 9.6 clocks in the case of PAL.

This counter serves as a sub-carrier oscillator which wraps around in the sub-carrier cycle so that the value of this counter indicates the phase thereof. Meanwhile, since the lower 2 bits of the counter are fixed in the case of NTSC, the lower 2 bits are gradually decreased to zero to provide the same pattern.

The video encoder 98 adds the hue “Hf” to the phase data of this sub-carrier to generate phase modulated phase data, which is the phase data of sub-carrier as phase-modulated by the hue “Hf”. Then, the video encoder 98 converts this phase modulated phase data into amplitude data by a waveform ROM. Furthermore, the video encoder 98 multiplies the amplitude data by the color saturation “Sf” to generate a signal (i.e., modulated color signal), which is amplitude modulated by the color saturation “Sf”. On the other hand, the video encoder 98 generates a brightness signal by adding an offset value of “8” to the brightness “Lf”.

The video encoder 98 generates a digital composite video signal by adding the brightness signal and the modulated color signal together, converts the digital composite video signal into an analog signal by means of an AD converter (not shown in the figure), and externally outputs the analog signal as an analog composite video signal “VD”.

When the composite blanking signal “BLK” is asserted, the video encoder 98 sets the brightness signal to a black level which is a value of “8” and, when the composite synchronization signal “SYN” is asserted, the video encoder 98 sets the brightness signal to a synchronization level which is a value of “0”. In addition, the video encoder 98 controls the hue and the color saturation respectively to be zero when the composite blanking signal “BLK” is asserted, and to be a constant value when the burst flag signal “BST” is asserted. Thus, in this case, the hue “Hf” and the color saturation “Sf” input from the color modulator 92 are not used. Furthermore, when the composite blanking signal “BLK” is asserted, the video encoder 98 outputs only the brightness signal as the composite video signal “VD” without adding the modulated color signal. However, even when the composite blanking signal “BLK” is asserted, the video encoder 98 outputs a color burst signal in a predetermined timing.

The video timing generator 100 generates the timing signals such as the horizontal scan count signal “HC”, the vertical scan count signal “VC”, the composite synchronization signal “SYN”, the composite blanking signal “BLK”, the burst flag signal “BST” and the alternating line signal “LA” on the basis of clock CK40.

The video timing generator 100 comprises a divider which changes the dividing ratio in accordance with the signal “VS”, i.e., depending upon whether NTSC or PAL. While the timing signals generated by the video timing generator 100 can be adjusted by the CPU 1, these signals are initialized such that one horizontal cycle comprises 2730 clocks of the clock signal “CK40” and one vertical cycle comprises 263 horizontal cycles in the case of NTSC. Also, in the case of PAL, these timing signals are initialized such that one horizontal cycle comprises 2724 clocks of the clock signal “CK40” and one vertical cycle comprises 314 horizontal cycles.

These dividing ratios are used for the purpose of providing horizontal and vertical cycles approximately corresponding to the standard cycles of NTSC and PAL and the interleave mode in accordance with the standard signals. In the case of NTSC standard, line and frame interleaving is performed with a differential phase of 180 degrees, while in the case of line interleaving based on PAL standard is performed with a differential phase of 270 degrees. However, in the case of PAL, frame interleaving of this embodiment is performed with a differential phase of 180 degrees, which differs from the standard phase. This phase difference is employed in order to lessen the dot-interference of the sub-carrier signal with the brightness signal in the case of non-interlaced scanning.

In this case, not shown in the figure, the video timing generator 100 is provided with a register for setting the horizontal cycle, a register for setting the left position of the horizontal synchronization pulse, a register for setting the right position of the equalizing pulse, a register for setting the right position of the horizontal synchronization pulse, a register for setting the left position of the color burst signal, a register for setting the right position of the color burst signal, a register setting the left position of a video field, a register for setting the right position of the vertical synchronization pulse, a register for setting the right position of the video field, a register for setting the horizontal cycle, a register for setting the bottom position of the video field, a register for setting the bottom position of the color burst signal, a register for setting the top position of the equalizing pulse, a register for setting the top position of the vertical synchronization pulse, a register for setting the bottom position of the vertical synchronization pulse, a register for setting the bottom position of the equalizing pulse, a register for setting the top position of the color burst and a register for setting the top position of the video field. Accordingly, the CPU 1 can adjust the general profile of the composite video signal “VD” by accessing these registers.

The video position adjuster 102, which is related to one of the characteristic features of the present invention, adjusts the position of the character screen in relation to the display screen (television frame). More specific description is as follows.

The video position adjuster 102 gives an offset to each of the horizontal scan count signal “HC” and the vertical scan count signal “VC” in order to generate the horizontal scan count signal “HP” and the vertical scan count signal “VP”. The horizontal scan count signal “HP” and the vertical scan count signal “VP” are output to the respective functional blocks used for generating the character screen as discussed above. The CPU 1 accesses the control registers 242, 244, 250 and 252 (refer to FIG. 17 to be described below), which are implemented within the video position adjuster 102, for setting the respective offsets. This will be described below in detail.

In this case, as has been discussed above, the bitmap generator 86 makes use of the horizontal scan count signal “HC” and the vertical scan count signal “VC” which are generated by the video timing generator 100. Accordingly, the video position adjuster 102 can adjust the relative position between the character screen and the bitmap screen.

The video function generator 104 determines the timing of finishing the drawing of each frame of the character screen on the basis of the horizontal scan count signal “HP” and the vertical scan count signal “VP”, and outputs a non-maskable interrupt signal “NMI” to the CPU 1 at the timing. By this configuration, the CPU 1 can be informed of when drawing one frame of the character screen is finished. Also, when both the horizontal scan count signal “HP” and the vertical scan count signal “VP” matches corresponding one of predetermined values stored in control registers (not shown in the figure), the video function generator 104 outputs an interrupt request signal “IRQ”. The CPU 1 can access these control registers in order to control the timing of the interrupt request signal “IRQ”. Furthermore, the video function generator 104 serves to latch the value of the horizontal scan count signal “HP” and the value of the vertical scan count signal “VP” in synchronization with the edges of light-pen input signals “LP0” and “LP1”.

The CPU 1 can read these values as latched through the first bus 31. Incidentally, the non-maskable interrupt signal “NMI” and the interrupt signal “IRQ” are output from the graphics processor 3 to the CPU 1 respectively as the interrupt request signals “INRQ”.

Meanwhile, the sprite DMA controller 50, the first background generator 56 and the second background generator 60 are provided respectively with a function of requesting the use of the first bus 31 so that they can actively obtain data from the main memory 17. Also, the character fetcher 68 and the bitmap generator 86 have a function of requesting the use of the first bus 31 and the second bus 33 so that they can actively obtain data from the main memory 17 and the external memory 45.

By the way, the pixel mixer 90 will be explained in detail.

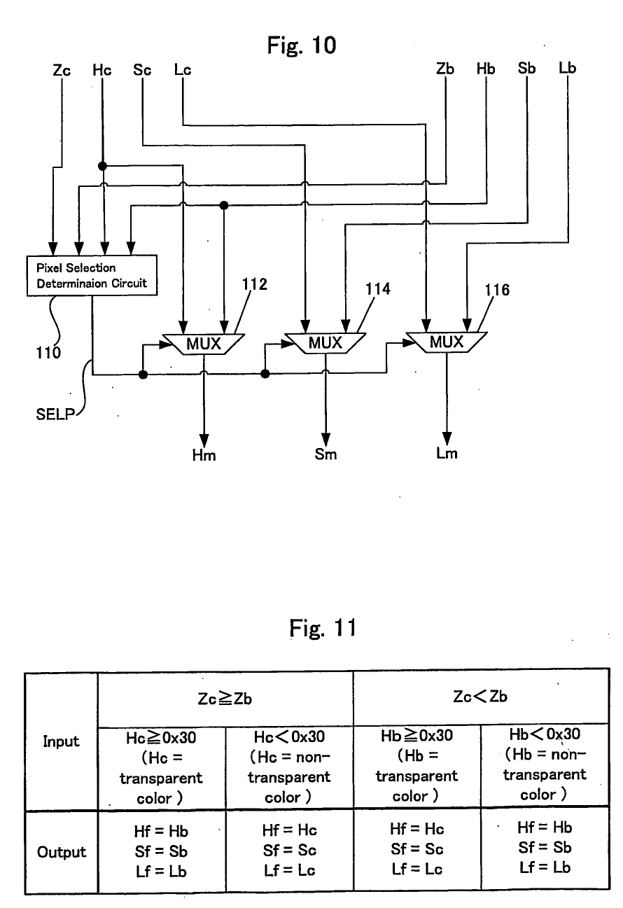

FIG. 10 is a block diagram showing the internal configuration of the pixel mixer 90 of FIG. 9. FIG. 11 is a truth table for determining the selected pixel by means of the pixel mixer 90 of FIG. 9.

As shown in FIG. 10, the pixel mixer 90 includes a pixel selection determination circuit 110 and multiplexers 112, 114 and 116. The pixel selection determination circuit 110 receives the depth information “Zc” and the hue information “Hc” contained in the pixel data item “PDC” of the character screen from the color palette controller 82 of FIG. 9. Also, the pixel selection determination circuit 110 receives the depth information “Zb” and the hue information “Hb” contained in the pixel data item “PDB” of the bitmap screen from the bitmap generator 86 of FIG. 9.

The pixel selection determination circuit 110 outputs to the multiplexers 112, 114 and 116 a select signal “SELP” for selecting one of the pixel data item “PDC” (the hue “Hc”, the color saturation “Sc” and the brightness “Lc”) of the character screen and the pixel data item “PDB” (the hue “Hb”, the color saturation “Sb” and the brightness “Lb”) of the bitmap screen in accordance with the truth table of FIG. 11. More specific description is as follows.

As illustrated in FIG. 11, the pixel selection determination circuit 110 outputs the select signal “SELP” for selecting the hue “Hb”, the color saturation “Sb” and the brightness “Lb” when the depth value “Zc”≧the depth value “Zb” and the hue “Hc”≧0x30 (i.e., the hue “Hc” indicates a transparent color). Also, the pixel selection determination circuit 110 outputs the select signal “SELP” for selecting the hue “Hc”, the color saturation “Sc” and the brightness “Lc” when the depth value “Zc”≧the depth value “Zb” and the hue “Hc”<0x30 (i.e., the hue “Hc” indicates a non-transparent color).

On the other hand, the pixel selection determination circuit 110 outputs the select signal “SELP” for selecting the hue “Hc”, the color saturation “Sc” and the brightness “Lc” when the depth value “Zc”<the depth value “Zb” and the hue “Hb”≧0x30 (i.e., the hue “Hb” indicates a transparent color). Also, the pixel selection determination circuit 110 outputs the select signal “SELP” for selecting the hue “Hb”, the color saturation “Sb” and the brightness “Lb” when the depth value “Zc”<the depth value “Zb” and the hue “Hb”<0x30 (i.e., the hue “Hb” indicates a non-transparent color).

As has been discussed above, the pixel selection determination circuit 110 generates the select signal “SELP” for selecting the pixel data item (“H”/“S”/“L”) having a larger depth value (that is, the foreground pixel data item). However, if the hue information of one pixel data item indicates a transparent color, the pixel selection determination circuit 110 generates the select signal “SELP” for selecting the other pixel data item (“H”/“S”/“L”) regardless of the depth information.

The multiplexer 112 selects one of the input hue information “Hc” of the character screen and the input hue information “Hb” of the bitmap screen in accordance with the select signal “SELP”, and outputs the selected hue information to the color modulator 92 as the hue information “Hm”. The multiplexer 114 selects one of the input color saturation information “Sc” of the character screen and the input color saturation information “Sb” of the bitmap screen in accordance with the select signal “SELP”, and outputs the selected color saturation information to the color modulator 92 as the color saturation information “Sm”. The multiplexer 116 selects one of the input brightness information “Lc” of the character screen and the input brightness information “Lb” of the bitmap screen in accordance with the select signal “SELP”, and outputs the selected brightness information to the color modulator 92 as the brightness information “Lm”.

As has been discussed above, the pixel mixer 90 mixes the character screen and the bitmap screen by successively selecting and outputting one of the pixel data item “PDC” of the character screen and the pixel data item “PDB” of the bitmap screen on the basis of the depth values “Zc” and “Zb” and the hue information “Hc” and “Hb”.

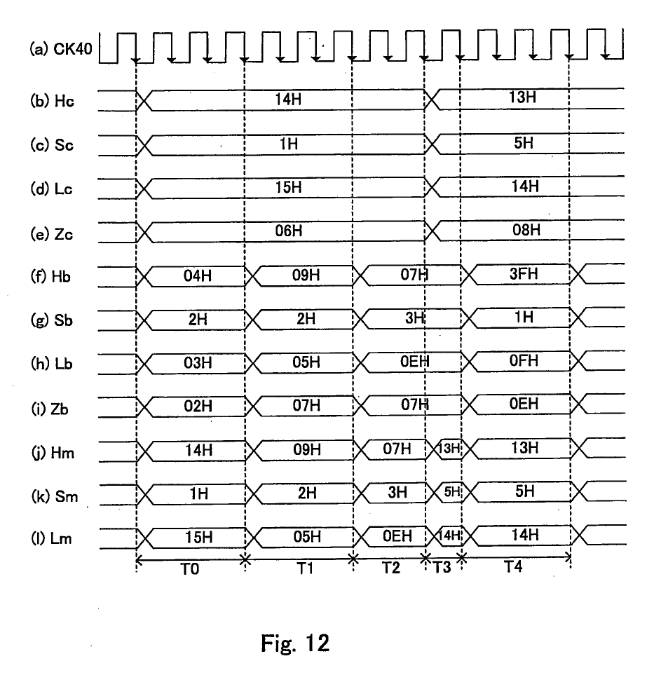

FIG. 12 is a timing chart showing an exemplary process of image mixing by the pixel mixer 90 of FIG. 9. As illustrated in FIG. 12 (signals (a) to (e)), since the period of outputting the data corresponding to one pixel of the character screen is 8 clocks of the clock signal “CK40”, the color palette controller 82 outputs the hue “Hc”, the color saturation “Sc”, the brightness “Lc” and the depth value “Zc” of the character screen at an output rate of 8 clocks per pixel of the clock signal “CK40”.

On the other hand, while the horizontal resolution of the bitmap screen is programmable, the data output rate is 3 clocks per pixel of the clock signal “CK40” in the case of the example of FIG. 12. Accordingly, as illustrated in FIG. 12 (signal (a) and signals (f) to (i)), the bitmap generator 86 outputs the hue “Hb”, the color saturation “Sb”, the brightness “Lb” and the depth value “Zb” of the bitmap screen at the output rate of 3 clocks per pixel of the clock signal “CK40”.

In the period “T0”, Zc>Zb such that (Hm, Sm, Lm)=(Hc, Sc, Lc) as illustrated in FIG. 12 (signals (j) to (l)). In the period “T1”, Zc<Zb such that (Hm, Sm, Lm)=(Hb, Sb, Lb). In the period “T2”, Zc<Zb such that (Hm, Sm, Lm)=(Hb, Sb, Lb). In the period “T3”, Zc>Zb such that (Hm, Sm, Lm)=(Hc, Sc, Lc). In the period “T4”, Zc<Zb but the hue “Hb” represents a transparent color (“3FH”), and therefore (Hm, Sm, Lm)=(Hc, Sc, Lc).

As described above, the pixel selection determination circuit 110 of the pixel mixer 90 determines the pixel data item (“H”/“S”/“L”) to be selected on the basis of the depth values “Zc” and “Zb” and the hues “Hc” and “Hb” every time the pixel data items “PDC” and “PDB” are input, and controls the multiplexers 112, 114 and 116 to select the pixel data items as selected.

By the way, the color palette controller 82 of FIG. 9 will be explained in detail.

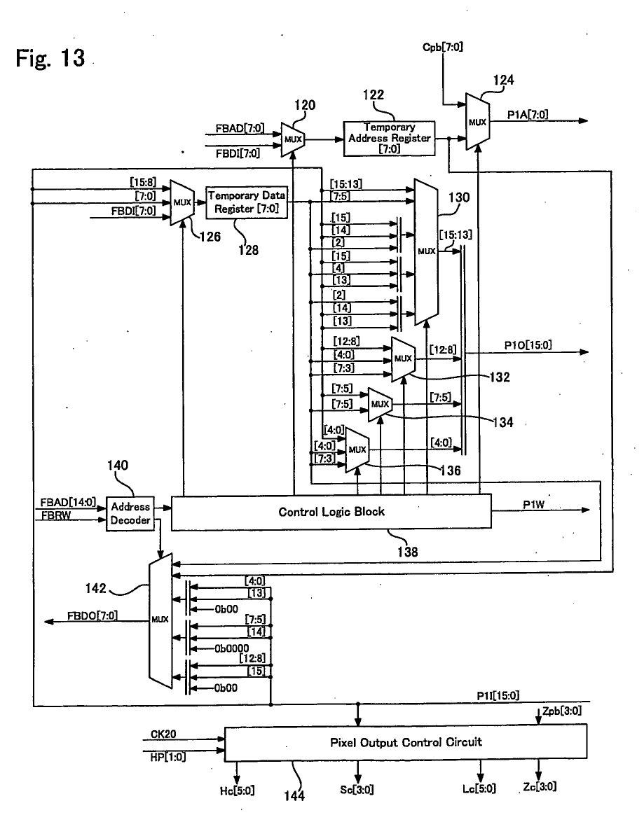

FIG. 13 is a block diagram showing the internal configuration of the color palette controller 82 of FIG. 9. As shown in FIG. 13, the color palette controller 82 includes multiplexers 120, 124, 126, 130, 132, 134, 136 and 142, a temporary address register 122, a temporary data register 128, an address decoder 140, a control logic block 138 and a pixel output control circuit 144.

The address decoder 140 outputs a control signal to the control logic block 138 for controlling the multiplexers 120, 124, 126, 130, 132, 134 and 136 on the basis of the result of decoding the address “FBAD[14:0]” of the first bus 31 and an internal read/write signal “FBRW”. The control logic block 138 outputs select signals to the multiplexers 120, 124, 126, 130, 132, 134 and 136 on the basis of this control signal. Also, the address decoder 140 outputs a select signal to the multiplexer 142 on the basis of the result of decoding the address “FBAD[14:0]” of the first bus 31 and the internal read/write signal “FBRW”. Each of the multiplexers 120, 124, 126, 130, 132, 134, 136 and 142 selects and outputs one of a plurality of signals input thereto in accordance with the select signal as input thereto.

In general, there are three types of access modes for accessing the character color palette 84 as follows. The first access mode is provided for updating the data of the color palette 84 which is mapped to the address space of the first bus 31. The second access mode is provided for updating the data of the color palette 84 through color component access ports. The third access mode is provided for reading the data of the color palette 84 for display.

In this case, each entry of the color palette 84 is 16 bits and stores color palette data [15:0] (a hue “H[5:0]”, a color saturation “S[3:0])” and a brightness “L[5:0]”). The color palette data [4:0] and [13] are respectively the hue “H[5:1]” and “H[0]”; the color palette data [7:5] and [14] are respectively the color saturation “S[3:1]” and “S[0]”; and the color palette data [12:8] and [15] are respectively the brightness “L[5:1]” and “L[0]”.

The first access mode will be explained. In the first access mode of the CPU 1 for accessing the color palette 84, while there is an advantage that different addresses are mapped to the respective entries of the color palette 84, there is a disadvantage that the CPU 1 has to perform a read-modify-write operation since the hue, the color saturation and the brightness are continuously arranged one after another without space within 16 bits. However, if 16-bit color data is simply written, it requires only a-write operation.

The 16-bit data is continuously arranged in the respective entries of the color palette 84 without unused bits. Because of this, when one or two of the hue “H”, the color saturation “S” and the brightness “L” is updated, or even if all of these three components are updated when these are processed, the CPU 1 has to perform a read-modify-write operation. In addition, since the LSBs of the hue “H”, the color saturation “S” and the brightness “L” are stored respectively in the 13th, 14th and 15th bits of the color palette 84, the CPU 1 has to perform a bit position rearrangement operation.

When a read-modify-write operation is needed, the CPU 1 first reads the color palette data from the color palette 84. This point will be explained in detail.

In the case where the address “FBAD[14:0]” of the first bus 31 points to any address of 0x6800 to 0x68FF, the lower byte data of an entry of the color palette 84 is accessed. On the other hand, in the case where the address “FBAD[14:0]” of the first bus 31 points to any address of 0x6900 to 0x69FF, the upper byte data of an entry of the color palette 84 is accessed.

If the internal read/write signal “FBRW” indicates a read operation while the address “FBAD[14:0]” points to an address in the above two areas, the control logic block 138 outputs a select signal to the multiplexers 120 and 124 for selecting the address “FBAD[7:0]” in accordance with the control signal output from the address decoder 140. The temporary address register 122 saves the address “FBAD[7:0]” which is then output to the color palette 84 by the multiplexer 124 as the color palette address “P1A[7:0]”.

If the internal read/write signal “FBRW” indicates a read operation, the control logic block 138 outputs a color palette read/write signal “P1W” indicative of a read operation to the color palette 84 in accordance with the control signal output from the address decoder 140. As a result, the color palette data “P1I” is read from the location pointed to by the color palette address “P1A[7:0]”.

In this case, the color palette 84 consists of 256 entries which are mapped to the address space of the first bus 31 in order that the lower 8 bits of the address “FBAD” of the first bus 31 correspond to an entry number (color number) of the color palette 84. Because of this, as has been discussed above, the address “FBAD[7:0]” is output to the color palette 84 as the color palette address “P1A[7:0]”.

If the internal read/write signal “FBRW” indicates a read operation while the address “FBAD” points to an any address of 0x6800 to 0x68FF, the control logic block 138 outputs a select signal to the multiplexer 126 for selecting the color palette data “P1I[7:0]” as read from the color palette 84 in accordance with the control signal output from the address decoder 140. Thereby, the color palette data “P1I[7:0]” is output from the multiplexer 126 to the temporary data register 128 and saved for a while in the temporary data register 128.

Accordingly, in this cycle of the read operation, the color palette data “P1I[7:0]” cannot be read yet. In the subsequent cycle of the read operation from the address of 0x6800 to 0x68FF, the address decoder 140 outputs a select signal to the multiplexer 142 for selecting the color palette data “P1I[7:0]” saved in the temporary data register 128, and then the multiplexer 142 outputs the color palette data “P1I[7:0]” as the internal data “FBDO[7:0]”.

Also, in the read operation from the address of 0x6900 to 0x69FF, the multiplexer 126 selects and outputs the color palette data “P1I[15:8]” to the temporary data register 128 in accordance with the control signal of the control logic block 138. The other controls are performed in the same manner as the above explained controls for the read operation from the address space of 0x6800 to 0x68FF, and therefore no redundant description is repeated.

The CPU 1 updates the color palette data “P1I” which is read as internal data “FBDO”, and then proceeds to the write operation. The write operation is commonly performed also in the case of updating all the three color components. The details are as follows. The CPU 1 outputs the updated color palette data to the multiplexer 126 as internal data “FBDI”. If the internal read/write signal “FBRW” indicates a write operation while the address “FBAD” points to any address of 0x6800 to 0x68FF and 0x6900 to 0x69FF, the control logic block 138 outputs a select signal to the multiplexer 126 for selecting the internal data “FBDI[7:0]” in accordance with the control signal output from the address decoder 140. By this configuration, the internal data “FBDI[7:0]” is saved in the temporary data register 128, and then output to the multiplexers 130, 132, 134 and 136.

If the internal read/write signal “FBRW” indicates a write operation while the address “FBAD” points to any address of 0x6800 to 0x68FF, the control logic block 138 first reads data from the color palette 84 in the first cycle. This is because one entry of the color palette 84 consists of 16 bits, while only the lower byte of the entry is rewritten, so that it has to be done to read the current value of the entry, rewrite the lower byte, and then write the updated 16-bit data to the entry. The control logic block 138 outputs a select signal for selecting the address “FBAD[7:0]” to the multiplexer 120 and a select signal for selecting the temporary address register 122[7:0] to the multiplexer 124 and sets the color palette read/write signal “P1W” to a read operation. In this cycle, the data of the entry pointed to by the color palette address “P1A[7:0]” is read as the color palette data “P1I[15:0]”.

In the second cycle, the control logic block 138 outputs select signals to the multiplexers 130, 132, 134 and 136 respectively for selecting the color palette data “P1I[15:13]” and “P1I[12:8]”, and the internal data “FBDI[7:5]” and “FBDI[4:0]” of the temporary data register 128. By this configuration, the color palette data “P1O[15:0]” as updated is output from the multiplexers 130, 132, 134 and 136 to the location of the color palette 84 pointed to by the color palette address “P1A” in accordance with the color palette read/write signal “P1W”.

If the internal read/write signal “FBRW” indicates a write operation while the address “FBAD” points to any address of 0x6900 to 0x69FF, the control logic block 138 first reads data from the color palette 84 in the first cycle. This is because one entry of the color palette 84 consists of 16 bits, while only the upper byte of the entry is rewritten, so that it has to be done to read the current value of the entry, rewrite the upper byte, and then write the updated 16-bit data to the entry. The control logic block 138 outputs a select signal to the multiplexer 120 for selecting the address “FBAD[7:0]”, and a select signal to the multiplexer 124 for selecting the temporary address register 122[7:0], and sets the color palette read/write signal “P1W” to a read operation. In this cycle, the data of the entry pointed to by the color palette address, “P1A[7:0]” is read as the color palette data “P1I[15:0]”.

In the second cycle, the control logic block 138 outputs select signals to the multiplexers 130, 132, 134 and 136 respectively for selecting the internal data “FBDI[7:5]” and “FBDI[4:0]” of the temporary data register 128, and the color palette data “P1I[7:5]” and “P1I[4:0]”. By this configuration, the color palette data “P1O[15:0]” as updated is output from the multiplexers 130, 132, 134 and 136 to the location of the color palette 84 pointed to by the color palette address “P1A” in accordance with the color palette read/write signal “P1W”.

The second access mode will be explained. In the first access mode, the CPU 1 has to perform a read modify write operation in such a case as one or two color components are updated and therefore the processing loading is increased. In the second access mode, individual access ports are provided respectively for the hue “H”, the color saturation “S” and the brightness “L” (i.e., three color components) in order to lessen the processing loading.

In the address space of the first bus 31, while the address 0x6F78 is set as an access port for the purpose of inputting the entry number of the color palette 84, the addresses 0x6F79, 0x6F7A and 0x6F7B are set as access ports respectively for the purpose of updating or reading the hue “H”, the color saturation “S” and the brightness “L”.

If the address “FBAD” is 0x6F78, the control logic block 138 outputs a select signal to the multiplexers 120 and 124 for selecting the internal data “FBDI” in accordance with the control signal as output from the address decoder 140. By this configuration, the internal data “FBDI” is output to the temporary address register 122 from the multiplexer 120, and saved in the temporary address register 122. In this case, the internal data “FBDI” designates the entry number (i.e., address) of an entry of the color palette 84. The internal data “FBDI” saved in the temporary address register 122 is selected by the multiplexer 124 and output to the color palette 84 as the color palette address “P1A”. Then, the color palette data “P1I” is read from the location pointed to by the address “P1A” in accordance with the color palette read/write signal “P1W” which is output from the control logic block 138 and designates a read operation, and output to the multiplexers 126, 130, 132, 134, 136 and 142. This operation is performed in the same manner as the operation of updating or reading the hue “H”, the color saturation “S” and the brightness “L”.

At first, the updating operation will be explained. If the internal read/write signal “FBRW” indicates a write operation while the address “FBAD” is 0x6F79 (i.e., the hue “H” is to be updated), the control logic block 138 first reads data from the color palette 84 in the first cycle. This is because, since only the hue “H” of one entry of the color palette 84 is updated, it is needed to read the current value of the entry, modify the hue “H” thereof and write back to the entry. The control logic block 138 outputs a select signal to the multiplexer 120 for selecting the internal data “FBDI[7:0]”, and a select signal to the multiplexer 124 for selecting the temporary address register 122[7:0], and sets the color palette read/write signal “P1W” to a read operation. In this cycle, the data of the entry pointed to by the color palette address “P1A[7:0]” is read as the color palette data “P1I[15:0]”. In addition, the control logic block 138 outputs a select signal for selecting the internal data “FBDI” to the multiplexer 126. By this configuration, the internal data “FBDI” is output from the multiplexer 126 to the temporary data register 128 and saved in the temporary data register 128. In this case, the internal data “FBDI” contains hue information “H” for use in the update operation. The internal data “FBDI[7:0]” consists of the upper 6 bits as the hue information “H” and the lower two bits which are filled with “0”.

In the second cycle, the control logic block 138 outputs a select signal to the multiplexer 130 for selecting the color palette data “P1I[15] [14]” and the internal data “FBDI[2]” of the temporary data register 128. By this configuration, the above data is output from the multiplexer 130 to the color palette 84 as the color palette data “P1O[15:13]”.

Furthermore, in this case, the control logic block 138 outputs select signals to the multiplexers 132, 134 and 136 respectively for selecting the color palette data “P1I[12:8]”, the color palette data “P1I[7:5]” and the internal data “FBDI[7:3]” of the temporary data register 128. By this configuration, the above data is output from the multiplexers 132, 134 and 136 to the color palette 84 as the color palette data “P1O[12:8]”, “P1O[7:5]” and “P1O[4:0]”. In addition, in the second cycle, the control logic block 138 sets the color palette read/write signal “P1W” to a write operation. By this configuration, the color palette data “P1O[15:0]” as output from the multiplexers 130, 132, 134 and 136 is written to the location pointed to by the color palette address “P1A” of the color palette 84.

On the other hand, if the internal read/write signal “FBRW” indicates an write operation while the address “FBAD” is 0x6F7A (i.e., the color saturation “S” is to be updated), the control logic block 138 first reads data from the color palette 84 in the first cycle. This is because, since only the color saturation “S” of one entry of the color palette 84 is updated, it is needed to read the current value of the entry, modify the color saturation “S” thereof and write back to the entry. The control logic block 138 outputs a select signal to the multiplexer 120 for selecting the internal data “FBDI[7:0]”, and a select signal to the multiplexer 124 for selecting the temporary address register 122[7:0], and sets the color palette read/write signal “P1W” to a read operation. In this cycle, the data of the entry pointed to by the color palette address “P1A[7:0]” is read as the color palette data “P1I[15:0]”. In addition, the control logic block 138 outputs a select signal to the multiplexer 126 for selecting the internal data “FBDI”. By this configuration, the internal data “FBDI” is output from the multiplexer 126 to the temporary data register 128 and saved in the temporary data register 128. In this case, the internal data “FBDI” contains color saturation information “S” for use in the update operation. The internal data “FBDI[7:0]” consists of the upper 4 bits as the color saturation information “S” and the lower 4 bits which are filled with “0”.

In the second cycle, the control logic block 138 outputs a select signal to the multiplexer 130 for selecting the color palette data “P1I[15]”, the internal data “FBDI[4]” of the temporary data register 128 and the color palette data “P1I[13]”. By this configuration, the above data is output from the multiplexer 130 to the color palette 84 as the color palette data “P1O[15:13]”.

Furthermore, in this case, the control logic block 138 outputs select signals to the multiplexers 132; 134 and 136 respectively for selecting the color palette data “P1I[12:8]”, the internal data “FBDI[7:5]” of the temporary data register 128 and the color palette data “P1I[4:01]”. By this configuration, the above data is output from the multiplexers 132, 134 and 136 to the color palette 84 as the color palette data “P1O[12:8]”, “P1O[7:5]” and “P1O[4:0]”. In addition, in the second cycle, the control logic block 138 sets the color palette read/write signal “P1W” to a write operation. By this configuration, the color palette data “P1O[15:0]” as output from the multiplexers 130, 132, 134 and 136 is written to the location pointed to by the color palette address “P1A” of the color palette 84.

Furthermore, if the internal read/write signal “FBRW” indicates an write operation while the address “FBAD” is 0x6F7B (i.e., the brightness “L” is to be updated), the control logic block 138 first reads data from the color palette 84 in the first cycle. This is because, since only the brightness “L” of one entry of the color palette 84 is updated, it is needed to read the current value of the entry, modify the brightness “L” thereof and write back to the entry. The control logic block 138 outputs a select signal to the multiplexer 120 for selecting the internal data “FBDI[7:0]”, and a select signal to the multiplexer 124 for selecting the temporary address register 122[7:0], and sets the color palette read/write signal “P1W” to a read operation. In this cycle, the data of the entry pointed to by the color palette address “P1A[7:0]” is read as the color palette data “P1I[15:0]”. In addition, the control logic block 138 outputs a select signal to the multiplexer 126 for selecting the internal data “FBDI”. By this configuration, the internal data “FBDI” is output from the multiplexer 126 to the temporary data register 128 and saved in the temporary data register 128. In this case, the internal data “FBDI” contains brightness information “L” for use in the update operation. The internal data “FBDI[7:0]” consists of the upper 6 bits as the brightness information “L” and the lower two bits which are filled with “0”.

In the second cycle, the control logic block 138 outputs a select signal to the multiplexer 130 for selecting the internal data “FBDI[2]” of the temporary data register 128, the color palette data “P1I[14]” and the color palette data “P1I[13]”. By this configuration, the above data is output from the multiplexer 130 to the color palette 84 as the color palette data “P1O[15:13]”.

Furthermore, in this case, the control logic block 138 outputs select signals to the multiplexers 132, 134 and 136 respectively for selecting the internal data “FBDI[4:0]” of the temporary data register 128, the color palette data “P1I[7:5]” and the color palette data “P1I[4:0]”. By this configuration, the above data is output from the multiplexers 132, 134 and 136 to the color palette 84 as the color palette data “P1O[12:8]”, “P1O[7:5]” and “P1O[4:0]”. In addition, in the second cycle, the control logic block 138 sets the color palette read/write signal “P1W” to a write operation. By this configuration, the color palette data “P1O[15:0]” as output from the multiplexers 130, 132, 134 and 136 is written to the location pointed to by the color palette address “P1A” of the color palette 84.

Next, the read operation will be explained. If the internal read/write signal “FBRW” indicates a read operation while the address “FBAD” is 0x6F79 (i.e., the hue “H” is to be read), the control logic block 138 outputs a select signal to the multiplexer 142 for selecting the color palette data “P1I[4:0]” and “P1I[13]” and a binary value of {0b00} in accordance with the control signal as output from the address decoder 140. By this configuration, these data elements are output as the internal data “FBDO[7:0]”. In this case, the internal data “FBDO[7:2]” can be used as the hue “H[5:0]”.

On the other hand, if the internal read/write signal “FBRW” indicates a read operation while the address “FBAD” is 0x6F7A (i.e., the color saturation “S” is to be read), the control logic block 138 outputs a select signal to the multiplexer 142 for selecting the color palette data “P1I[7:5]” and “P1I[14]” and a binary value of {0b000} in accordance with the control signal as output from the address decoder 140. By this configuration, these data elements are output as the internal data “FBDO[7:0]”. In this case, the internal data “FBDO[7:4]” can be used as the color saturation “S[3:0]”.

If the internal read/write signal “FBRW” indicates a read operation while the address “FBAD” is 0x6F7B (i.e., the brightness “L” is to be read), the control logic block 138 outputs a select signal to the multiplexer 142 for selecting the color palette data “P1I[12:8]” and “P1I[15]” and a binary value of {0b00} in accordance with the control signal as output from the address decoder 140. By this configuration, these data elements are output as the internal data “FBDO[7:0]”. In this case, the internal data “FBDO[7:2]” can be used as the brightness “L[5:0]”.

The third access mode will be explained. If the access mode is neither the first access mode nor the second access mode, the control logic block 138 outputs a select signal to the multiplexer 124 for selecting the pixel color code “Cpb” and outputs to the color palette 84 the color palette read/write signal “P1W” designating a read operation. By this configuration, the pixel color code “Cpb” is output to the color palette 84 as the color palette address “PIA”, and the color palette data “P1I” is read from the location pointed to by the color palette address “PIA” and output to the pixel output control circuit 144.

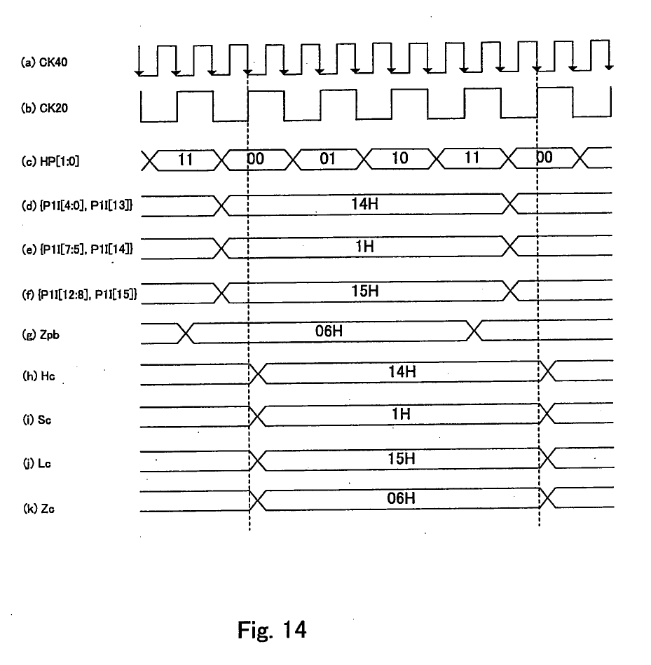

FIG. 14 is a timing chart to explain the action of the pixel output control circuit 144 of FIG. 13. As shown in FIG. 14 (signals (a) to (g)), in the case where the horizontal scan count signal “HP[1:0]” are {0b00} and the internal clock signal “CK20” is “0”, the pixel output control circuit 144 latches the color palette data “P1I[15:0]” and the depth value “Zpb” at the falling edge of the internal clock signal “CK40”.

Also, as shown in FIG. 14 (signals (h) to (k)), the pixel output control circuit 144 outputs to the pixel mixer 90 the latched color palette data “P1I[4:0]” and “P1I[13]” as the hue information “Hc”, the latched color palette data “P1I[7:5]” and “P1I[14]” as the color saturation “Sc”, and the latched color palette data “P1I[12:8]” and “P1I[15]” as the brightness “Lc”. Also, the latched depth value “Zpb” is output to the pixel mixer 90 as the depth value “Zc”.

As has been discussed above, the pixel output control circuit 144 outputs the hue “Hc”, the color saturation “Sc”, the brightness “Lc” and the depth value “Zc” to the pixel mixer 90 at the output rate (horizontal pixel resolution) of 8 clocks per pixel of the clock signal “CK40”.

In this case, the condition that the horizontal scan count signal “HP[1:0]” is {0b00} is provided, as a condition required for latching the color palette data P1I[15:0], in order to align the horizontal positions of the pixels on the respective horizontal lines with each other without misalignment in the vertical direction.

Next, the bitmap generator 86 of FIG. 9 will be explained in detail.

FIG. 15 is a block diagram showing the internal configuration of the bitmap generator 86 of FIG. 9. As shown in FIG. 15, the bitmap generator 86 includes a control register 158 for storing the value “Hfin” which is used to finely adjust the horizontal position of the bitmap screen (refer to FIG. 4), a control register 160 for setting the horizontal pixel resolution (j clocks per pixel (j=2 to 16) of the clock signal “CK40”), a control register 162 for setting the display left edge coordinate “BPL” (refer to FIG. 3), a control register 164 for setting the display right edge coordinate “BPR”, a control register 166 for setting the display upper edge coordinate “BPT”, a control register 168 for setting the display lower edge coordinate “BPB” and the control register 170 for setting a display control bit indicative of whether or not the bitmap display is made active.

Also, the bitmap generator 86 includes a control register 172 for setting the right edge address “BAR” (refer to FIG. 6), the control register 174 for setting the left edge address “BAL”, the control register 176 for setting the top address “BAT”, a control register 178 for setting the address step “BAS”, the control register 180 for setting the base address “BBS”, a control register 226 for setting the color mode (the number of bits per pixel, i.e., M bits per pixels) of the bitmap screen, and a control register 232 for setting the depth value “Zb” of the bitmap screen.

The CPU 1 can access the control registers 158 to 180, 226 and 232 through the first bus 31 and the first bus interface circuit 156, and can set or change the values in these control registers.

Furthermore, the bitmap generator 86 includes a base point signal generation circuit 150 composed of comparators 152 and 154, a pixel clock generation circuit 182, a horizontal coordinate counter 184, a horizontal coordinate display area judgment circuit 186, a vertical coordinate counter 188, a vertical coordinate display area judgment circuit 190, a horizontal address counter 194, a vertical address counter 198, a horizontal address increment control circuit 204, a write control circuit 206, a FIFO (first-in-first-out) register 208, a read control circuit 210, a funnel shifter 216, a bit address counter 228, an upper bit mask circuit 218, a color palette access port 230, a color palette interface circuit 220, a pixel output control circuit 234, AND gates 192 and 222, a comparator 196, a bus use request signal generation circuit 224, adders 200 and 202 and a subtractor 212.

When the horizontal scan count signal “HC[12:5]” reaches {0x00} and the horizontal scan count signal “HC[4:1]” reaches the value “Hfin” of the horizontal position fine adjustment register [3:0], the comparator 154 of the base point signal generation circuit 150 asserts the horizontal coordinate base point signal “HBP”. On the other hand, when the vertical scan count signal “VC[9:1]” reaches {0x20}, the comparator 152 of the base point signal generation circuit 150 asserts a vertical coordinate base point signal “VBP”.

When the horizontal coordinate base point signal “HBP” is asserted or a 4-bit pixel clock counter (not shown in the figure) becomes {0b0000}, the pixel clock generation circuit 182 loads the value of the horizontal pixel resolution register 160 to the pixel clock counter. The pixel clock counter performs a decrement operation on each falling edge of the internal clock signal “CK40”, and asserts a pixel clock signal “PCK” when the pixel clock counter becomes {0b0000}.

The horizontal coordinate counter 184 is cleared to “0” when the horizontal coordinate base point signal “HBP” is asserted, and performs an increment operation every time the pixel clock signal “PCK” is asserted.

If the vertical coordinate base point signal “VBP” is asserted, the vertical coordinate counter 188 is cleared to “0” when the horizontal coordinate base point signal “HBP” is asserted, and then if the vertical coordinate base point signal “VBP” is not asserted, the vertical coordinate counter 188 counts up each time the horizontal coordinate base point signal “HBP” is asserted.

When the pixel clock signal “PCK” is asserted, the horizontal coordinate display area judgment circuit 186 asserts a horizontal coordinate area signal “HWI” if the value of the horizontal coordinate counter 184 is equal to the value “BPL” of the display left edge coordinate register 162. Also, when the pixel clock signal “PCK” is asserted, the horizontal coordinate display area judgment circuit 186 negates the horizontal coordinate area signal “HWI” if the value of the horizontal coordinate counter 184 is equal to the value “BPR” of the display right edge coordinate register 164. If the value of the horizontal coordinate counter 184 is not equal to either the value “BPR” of the display right edge coordinate register 164 or the value “BPL” of the display left edge coordinate register 162, the horizontal coordinate display area judgment circuit 186 maintains the logic of the horizontal coordinate area signal “HWI”.

When the horizontal coordinate base point signal “HBP” is asserted, the vertical coordinate display area judgment circuit 190 asserts a vertical coordinate area signal “VWI” if the value of the vertical coordinate counter 188 is equal to the value “BPT” of the display upper edge coordinate register 166. Also, when the horizontal coordinate base point signal “HBP” is asserted, the vertical coordinate display area judgment circuit 190 negates the vertical coordinate area signal “VWI” if the value of the vertical coordinate counter 188 is equal to the value “BPB” of the display bottom edge coordinate register 168. If the value of the vertical coordinate counter 188 is not equal to either the value “BPB” of the display bottom edge coordinate register 168 or the value “BPT” of the display upper edge coordinate register 166, the vertical coordinate display area judgment circuit 190 maintains the logic of the vertical coordinate area signal “VWI”.

When the horizontal coordinate base point signal “HBP” is asserted, the horizontal address counter 194 loads the value “BAL” of the left edge address register 174. The horizontal address counter 194 is controlled by the horizontal address increment control circuit 204 to increment its count value.

When 16-bit external data “SBDI” is read through the second bus 33, i.e., when both the second bus lower byte read acknowledge signal “SLRG” and the second bus upper byte read acknowledge signal “SURG” are asserted, the horizontal address increment control circuit 204 controls the horizontal address counter 194 to increment its count value by two.

When 8-bit data “FBDI” or “SBDI” is read through the first bus 31 or the second bus 33, i.e., when one of the second bus lower byte read acknowledge signal “SLRG” and the second bus upper byte read acknowledge signal “SURG” is asserted, or when the first bus read acknowledge signal “FBRG” is asserted, the horizontal address increment control circuit 204 controls the horizontal address counter 194 to increment its counter value by one.

When the horizontal coordinate base point signal “HBP” is asserted, the vertical address counter 198 loads the value “BAT” of the top address register 176 if the vertical coordinate base point signal “VBP” is asserted. Also, if the vertical coordinate area signal “VWI” is asserted while the vertical coordinate base point signal “VBP” is negated, the vertical address counter 198 adds the value “BAS” of the address step register 178 to the current counter value.

When the horizontal coordinate base point signal “HBP” is asserted, the bit address counter 228 clears the current counter value to “0”. Also, every time the pixel clock signal “PCK” is asserted while the horizontal coordinate area signal “HWI” is asserted, the bit address counter 228 performs an increment operation. In this case, the bit address counter 228 counts up by the value of the color mode (M bits per pixel: M=1 to 8) indicated by the color mode setting register 226 every time an increment operation is performed. By this configuration, the lower three bits of the bit address counter 228 points to the initial bit position within a byte of the pixel data (the color code of one pixel).

The FIFO register 208 stores, in bytes, the internal data “FBDI” read from the memory 17 which is connected to the first bus 31, or the external data “SBDI” from the memory 45 which is connected to the second bus 33. This FIFO register 208 serves as a buffer which absorbs the differential time between the reading of data from the memory MEM and the outputting of pixel data (“Hb”/“Sb”/“Lb” data of one pixel) for displaying. Incidentally, the number of stages of the FIFO register 208 is 16.

The write control circuit 206 writes, to the FIFO register 208, the internal data “FBDI” read from the memory 17 connected to the first bus 31 or the external data “SBDI” read from memory 45 connected to the second bus 33. More specific description is as follows.

The write control circuit 206 obtains the internal data “FBDI[7:0]” from the first bus 31 when the first bus read acknowledge signal “FBGR” is asserted, obtains the external data “SBDI[7:0]” from the second bus 33 when the second bus lower byte read acknowledge signal “SLRG” is asserted, and obtains the external data “FBDI[15:8]” from the second bus 33 when the second bus upper byte read acknowledge signal “SURG” is asserted.

Also, the write control circuit 206 makes use of the lower 4 bits of the horizontal address counter 194 as a write pointer of the FIFO register 208.

The read control circuit 210 makes use of the counter value [6:3] of the bit address counter 228 as a read pointer of the FIFO register 208, reads one byte pointed to by the read pointer together with the subsequent byte, totaling to two bytes, from the FIFO register 208, and outputs them to the funnel shifter 216. Two bytes are read in this manner because pixel data (the color code of one pixel) can span two bytes depending upon the color mode as set in the color mode setting register 226. Incidentally, the counter value [2:0] of the bit address counter 228 serves to point to the initial bit of the pixel data (the color code of one pixel) within a byte.

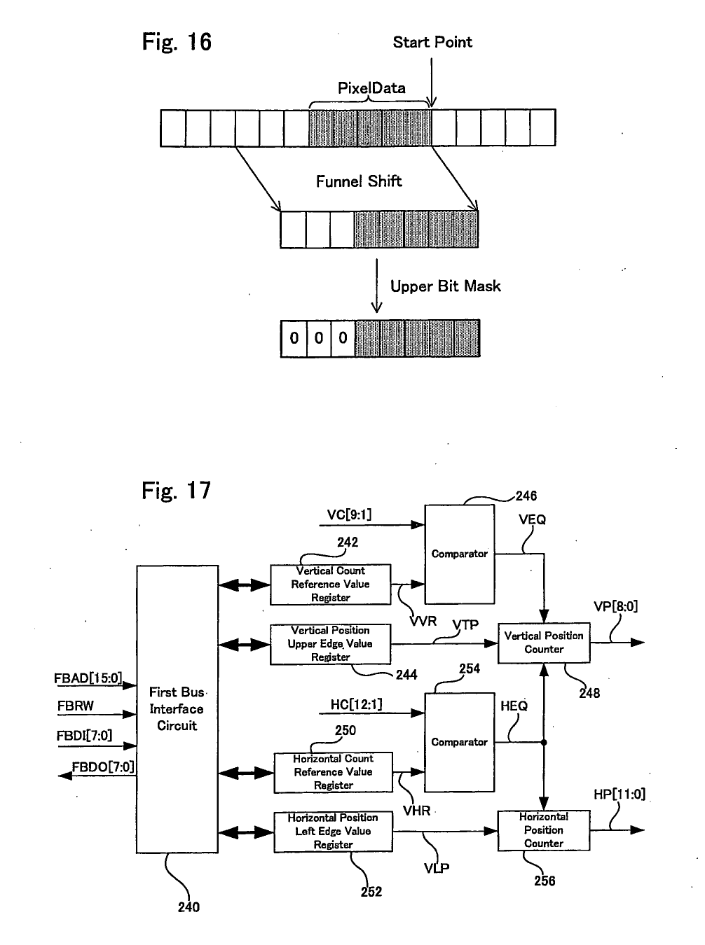

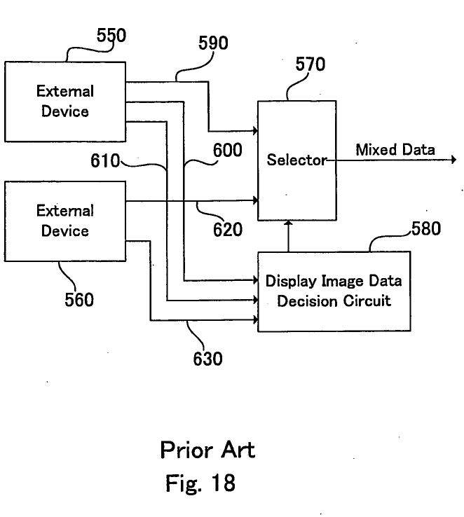

FIG. 16 is an explanatory view for showing the funnel shifter 216 and the upper bit mask circuit 218 of FIG. 15. As shown in FIG. 16, the funnel shifter 216 retrieves, from 16-bit data as input from the read control circuit 210, 8-bit data starting from the location pointed to by the counter value [3:0] of the bit address counter 228, and outputs it to the upper bit mask circuit 218. In FIG. 16, the shadow portion is the pixel data (the color code of one pixel).

The upper bit mask circuit 218 puts a mask on the upper 1 to 7 bits of the 8 bits as input from the funnel shifter 216 in accordance with the color mode as set in the color mode setting register 226 to fix the masked bits to “0” irrespective of the input value. In the case of an example shown in FIG. 16, the color mode is 5 bits per pixel to mask the upper three bits which are set to “0” respectively.

Returning to FIG. 15, the color palette interface circuit 220 outputs the 8-bit data as input from the upper bit mask circuit 218 to the color palette 88 as an address (referred to hereinbelow as a color palette address “P2A”) of the bitmap color palette 88. Then, the color palette data (the hue “Hb”, the color saturation “Sb”, and the brightness “Lb”) “P2I” is read from the color palette 88, which is then output to the pixel output control circuit 234 by the color palette interface circuit 220. Incidentally, in this case, the color palette read/write signal “P2W” always indicates a read operation.

Also, when accepting an access request for the color palette 88 through the color palette access port 230, the color palette interface circuit 220 gives priority to this access request and performs a read or write operation to the color palette 88. For this reason, it is desirable to update the color palette 88 through the color palette access port 230 during the period when the bitmap screen is not displayed. Meanwhile, the CPU 1 can access the color palette access port 230 through the first bus 31 and the first bus interface circuit 156.

The pixel output control circuit 234 outputs 16-bit data “P2I” as input from the color palette interface circuit 220 to the pixel mixer 90 as the hue data “Hb[5:0]”, the color saturation data “Sb[3:0]” and the brightness data “Lb[5:0]” during the period when a coordinate area signal “HVWI” to be described below is asserted. However, the pixel output control circuit 234 outputs {0b111111} as the hue data “Hb[5:0]”, {0b0000} as the color saturation data “Sb[3:0]” and {0b000000} as the brightness data “Lb[5:0]” of the pixel during the period when the coordinate area signal “HVWI” is negated. This combination of data is used to designate a transparent color of the pixel.

Also, the value which is set in the depth setting register 232 is continuously output to the pixel mixer 90 as the depth data “Zb[3:0]” of the pixel.

As has been discussed above, the bit address counter 228 is incremented every time the pixel clock signal “PCK” having the frequency corresponding to the horizontal pixel resolution is asserted, while the color palette data “P2I” is read and output to the pixel output control circuit 234 in accordance with this counter value. Accordingly, the color palette data (the hue “Hb”, the color saturation “Sb”, and the brightness “Lb”) “P2I” is output to the pixel mixer 90 at the output rate corresponding to the horizontal pixel resolution of the bitmap screen.

The AND gate 192 asserts the coordinate area signal “HVWI” when both the horizontal coordinate area signal “HWI” and the vertical coordinate area signal “VWI” are asserted.

The comparator 196 determines whether or not the counter value of the horizontal address counter 194 falls between the value “BAR” of the right address register 172 and the value “BAL” of the left address register 174, and if it falls therebetween the comparator 196 asserts an area signal “RAN”.

The subtractor circuit 212 subtracts the value of the bit address counter [6:3] (the read pointer of the FIFO register 208), which is output from the read control circuit 210, from the lower 4 bits of the value of the horizontal address counter 194 (the write pointer of the FIFO register 208), which is output from the write control circuit 206, and then outputs the result of subtraction to the comparator 214.

The comparator 214 compares the result of subtraction by the subtractor circuit 212 with “8”, and asserts a comparison result signal “LE” if the result of subtraction is no larger than “8”.

The AND gate 222 asserts a bus use request signal “BRQ” if the coordinate area signal “HVWI” is asserted, if the display control bit of the display active register 170 is “true”, if the area signal “RAN” is asserted (that is, the counter value of the horizontal address counter 194 falls between the left address register 174 and the right address register 172), and if the comparison result signal “LE” is asserted (the difference between the write pointer and the read pointer of the FIFO register 208 is no larger than “8”).

In this case, the FIFO register 208 serves as a ring buffer in which if the write pointer wraps around and advances ahead of the read pointer, appropriate display becomes impossible so that reading bitmap data from the memory MEM is performed only when the difference between the write pointer and the read pointer is no larger than “8” in order to prevent the write pointer from advancing ahead of the read pointer.

When the bus use request signal “BRQ” is asserted, the bus use request signal generation circuit 224 asserts the first bus use request signal “FBRQ” if both address bits “EIAD[23]” and “EIAD[15]” to be described below are “0”, and asserts the second bus use request signal “SBRQ” if at least one of the address bits “EIAD[23]” and “EIAD[15]” is “1”. The physical address space of the first bus 31 is mapped to the area of the logical address space corresponding to the logical addresses of which both the 23rd bit and the 15th bit are “0”, while the physical address space of the second bus 14 is mapped to the remaining area of the logical address space.

The adder circuit 200 adds the value of the horizontal address counter 194 to the value of the vertical address counter 198 which is shifted to the left by concatenating three bits of “0” to the LSB thereof as the lower three bits, and outputs the result of addition to the adder 202.

The adder circuit 202 adds the result of addition output from the adder 200 to the value “BBS” of the base address register 180 which is shifted to the left by concatenating 11 bits of “0” to the LSB thereof as the lower 11 bits, and outputs the result of addition as the address “EIDA[26:0]”.

Accordingly, the address “EIDA[26:0]” for use in reading the bitmap data is generated by adding together {the base address [15:0], 0b00000000000}, {the vertical address [14:0], 0b000} and {the horizontal address [9:0]}.

By the way, the video position adjuster 102 of FIG. 9 will be described below in detail.

FIG. 17 is a block diagram showing the internal configuration of the video position adjuster 102 of FIG. 9. As shown in FIG. 17, the video position adjuster includes a vertical count reference value register 242, a vertical position upper edge value register 244, a horizontal count reference value register 250, a horizontal position left edge value register 252, a vertical position counter 248, a horizontal position counter 256, comparators 246 and 254 and a first bus interface circuit 240.

The comparator 254 asserts a match signal “HEQ” when the horizontal scan count signal “HC[12:1]” as input from the video timing generator 100 reaches the value “VHR” of the horizontal count reference value register 250 (refer to FIG. 7).

When the match signal “HEQ” is asserted, the value “VLP” of the horizontal position left edge value register 252 is loaded into the horizontal position counter 256 as the horizontal scan count signal “HP[11:0]”. Otherwise, the horizontal scan count signal “HP” is incremented every cycle of the internal clock signal “CK40”.

On the other hand, when the vertical scan count signal “VC[9:1]” as input from the video timing generator 100 matches the value “VVR” of the vertical count reference value register 242, the comparator 246 asserts the match signal “VEQ”.

When both the match signal “VEQ” and the match signal “HEQ” are asserted, the value “VTP” of the vertical position upper value register 244 is loaded into the vertical position counter 248 as the vertical scan count signal “VP[8:0]”. Otherwise, the vertical scan count signal “VP” is incremented every time the match signal “HEQ” is asserted.

The CPU 1 can access the vertical count reference value register 242, the vertical position upper value register 244, the horizontal count reference value register 250, and the horizontal position left value register 252 through the first bus 31 and the first bus interface circuit 240, and set and modify the values contained in these registers.

As has been discussed above, offsets are added respectively to the horizontal scan count signal “HC” and the vertical scan count signal “VC” in order to generate the horizontal scan count signal “HP” and the vertical scan count signal “VP” which are used for displaying the character screen. By this configuration, it is possible to adjust the display position of the character screen.

By the way, as described above, the pixel data (the hue “Hc”, the color saturation “Sc” and the brightness “Lc”, and the hue “Hb”, the color saturation “Sb” and the brightness “Lb”) are input from the color palette controller 82 and the bitmap generator 86 to the pixel mixer 90 at the output rates as respectively set. Then, the pixel mixer 90 mixes the character screen and the bitmap screen by determining color information (the hue “Hm”, the color saturation “Sm” and the brightness “Lm”) of the pixel to be output in accordance with the depth values “Zc” and “Zb” of the respective pixels as output from the color palette controller 82 and the bitmap generator 86. During this mixing process, the color palette controller 82 outputs pixel data (the depth value “Zc”, the hue “Hc”, the color saturation “Sc” and the brightness “Lc”) to the pixel mixer 90 at the output rate (8 clocks per pixel) corresponding to the horizontal resolution of the character screen. On the other hand, the bitmap generator 86 outputs pixel data (the depth value “Zb”, the hue “Hb”, the color saturation “Sb” and the brightness “Lb”) to the pixel mixer 90 at the output rate (2 to 16 clocks per pixel) corresponding to the horizontal pixel resolution which is set in the horizontal pixel resolution register 160. Accordingly, even in the case where the pixel width of the character screen differs from the pixel width of the bitmap screen, i.e., in the case where the horizontal resolutions thereof differs from each other, these screens can be mixed.

Also, the pixel data output respectively from the color palette controller 82 and the bitmap generator 86 contains the depth values “Zc” and “Zb”. In other words, a depth value is associated with each pixel of the character screen and the bitmap screen to be mixed. Incidentally, a character screen is generated by mixing sprites, a first background screen and a second background screen and therefore the depth value “Zc” of each pixel can take any one of the depth value “Z0” which is commonly assigned to the sprite to be displayed at the pixel, the depth value “Z1” which is commonly assigned to the character of the first background screen to be displayed at the pixel, and the depth value “Z3” which is commonly assigned to the character of the second background screen to be displayed at the pixel, while the depth values of the respective sprites and characters can be set to different values. Then, if pixels overlap, the pixel mixer 90 makes a selection of one of the pixels on the basis of the depth values “Zc” and “Zb” of the respective pixels. Because of this, the foreground-background relationship is not determined between the respective images to be mixed. In other words, the foreground-background relationship is determined between the respective pixels at the same position of the character screen and the bitmap screen.

Accordingly, it is possible to mix these screens in order that the bitmap screen is placed behind a first area of the character screen and over a second area of the character screen. In this manner, it is possible not only to set the order of display priority for the images to be mixed and recognized respectively as inseparable, but also to set the order of display priority for the constituent elements of each image.

In addition to this, the character screen is a mixed image which is generated on the basis of the depth values “Z0”, “Z1” and “Z3”. However, the character screen contains the depth values “Zc” of the respective pixels, and therefore it is possible to mix the character screen and the bitmap screen in accordance with an desired order of display priority irrespective of the order of mixing. Namely, in this case, the character screen is first mixed, and then the bitmap screen is mixed with the character screen. However, it is possible to mix them in order that the object obj2 of the bitmap screen is placed between the object obj3 of the character screen and the object obj1 of the character screen (refer to FIG. 2).

Also, in accordance with the present embodiment, since the pixel mixer 90 always does not select and output any transparent pixel, even if the selection of pixels are made on the basis of the depth values “Zc” and “Zb”, the transparent pixel is not selected and output even though it is placed in a foreground position, and therefore it is possible to select and output the appropriate pixel as intended.

Furthermore, in accordance with the present embodiment, it is possible to arbitrarily adjust, on the display screen, the location of the character screen composed of color codes which are read from the memory MEM on the basis of the horizontal scan count signal “HP” and the vertical scan count signal “VP” by setting appropriate values respectively in the horizontal count reference value register 250, the horizontal position left value register 252, the vertical count reference value register 242, and the vertical position upper value register 244. In addition, it is possible to adjust the relative display position between the bitmap screen composed of color codes which are read from the memory MEM in accordance with the horizontal scan count signal “HC” and the vertical scan count signal “VC” and the character screen composed of color codes which are read from the memory MEM in accordance with the horizontal scan count signal “HP” and the vertical scan count signal “VP”.

Furthermore, in accordance with the present embodiment, the color palettes 84 and 88 are provided respectively for the color palette controller 82 and the bitmap generator 86, i.e., respectively for the character screen and the bitmap screen to be mixed. Generally speaking, in the case of a system making use of a color palette for converting a color code into color information (containing a hue, a color saturation and a brightness), the color code is composed of a fewer number of bits than the color information so that there is an advantage that the image data can occupy only a smaller area of a memory in which the image data is stored, but there is a disadvantage that the range of colors as available in the same screen is narrowed. Contrary to this, in accordance with the present embodiment, the separate color palettes 84 and 88 are provided respectively for the color palette controller 82 and the bitmap generator 86, and therefore it is possible to increase the number of colors as available in the same screen without increasing the size of the image data and extend the range of color expression for greater diversity.

Furthermore, in accordance with the present embodiment, since the horizontal coordinate counter 184 for regulating the horizontal position of the bitmap screen is initialized by the use of the value as set in the horizontal position fine adjustment register 158, it is possible to fine-adjust the horizontal position of the bitmap screen by setting an appropriate value in the horizontal position fine adjustment register 158.

Furthermore, in accordance with the present embodiment, the bitmap generator 86 reads data in words from the memory MEM of which one word consists of N bit (N is 2 or larger integer), extracts, on a pixel-by-pixel basis, color codes each of which represents one pixel by M bits (M is 1 or a larger integer) and which are continuously arranged in the memory MEM without space, converts the color code as extracted into color information (the hue “Hb”, the color saturation “Sb” and the brightness “Lb”), and outputs the color information to the pixel mixer 90 together with the depth value “Zb”.

Since the bitmap generator 86 extracts the color code corresponding to one pixel from the data which is read from the memory MEM, it is possible to continuously arrange color codes in the memory MEM in order not to leave unused bits therebetween in the respective words irrespective of the number of bits per pixel (color mode). In other words, regardless of whether or not each of N/M and M/N is an integer, it is possible to fill an area of the memory MEM with the data in order not to leave unused bits therebetween in the respective words. Because of this, the memory area can be efficiently and effectively used.

Meanwhile, the present invention is not limited to the above embodiments, and a variety of variations and modifications may be effected without departing from the spirit and scope thereof, as described in the following exemplary modifications.

In the above embodiment, an indirect color representation method is employed by the use of the color palettes 84 and 88. In other words, the character pattern data and the bitmap data are represented by color codes. However, the system for representing colors is not limited thereto, but the present invention is similarly applicable to the case where colors are described in terms of the hue “H”, the color saturation “S” and the brightness “L”, or in terms of any other color space. In this case, the color information of bitmap data can be read from the memory MEM or internally generated by the graphics processor 3. Also, in this case, the pixel mixer 90 receives, for example, pixel data (the depth value “Zc”, the hue “Hc”, the color saturation “Sc” and the brightness “Lc”) in the output timing in synchronization with the horizontal scan count signal “HP” and the vertical scan count signal “VP” at the output rate (8 clocks per pixel) corresponding to the horizontal pixel resolution of the character screen, and pixel data (the depth value “Zb”, the hue “Hb”, the color saturation “Sb” and the brightness “Lb”) in the output timing in synchronization with the horizontal scan count signal “HC” and the vertical scan count signal “VC” at the output rate (2 to 16 clocks per pixel) corresponding to the horizontal pixel resolution of the bitmap screen.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

1. An image mixing apparatus operable to mix on a display screen a plurality of images each of which has a different width of pixels relative to the display screen, said image mixing apparatus comprising:
a plurality of pixel output units operable to output pixel data items each of which includes color information and a depth value of the corresponding image at output rates which are set respectively for said pixel output units; and
a pixel mixer operable to receive the pixel data items as output from said plurality of pixel output units, and output the color information of the pixel data item whose the depth value indicates, among the depth values of the pixel data items, that the pixel corresponding thereto is located in a foreground position among the pixels corresponding to the pixel data items,
wherein the depth value is a value indicative of the depth position of the pixel of the corresponding image,
wherein the color information is information indicative of a color of the pixel forming the corresponding image, and
wherein the output rates of at least two of said pixel output units are set to different values.

2. An image mixing apparatus operable to mix on a display screen a plurality of images each of which has a different width of pixels relative to the display screen, said image mixing apparatus comprising:
a plurality of pixel output units operable to output pixel data items each of which includes color information and a depth value of the corresponding image at output rates which are set respectively for said pixel output units; and
a pixel mixer operable to receive the pixel data items as output from said plurality of pixel output units, and output the color information of the pixel data item whose the depth value indicates, among the depth values of the pixel data items, that the pixel corresponding thereto is located in a foreground position among the pixels corresponding to the pixel data items,
wherein the depth value is a value indicative of the depth position of the pixel of the corresponding image,
wherein the color information is information indicative of a color of the pixel forming the corresponding image, and
wherein at least one of said pixel output units is provided with a storage unit which is used to set the output rate and can be rewritten by an external device.

3. The image mixing apparatus as claimed in claim 1 wherein said pixel mixer does not output the color information of the pixel data item, if the color information of the pixel data item indicates that the pixel is transparent, irrespective of the depth value of the pixel data item, while said pixel mixer outputs the color information of the pixel data item having the depth value which indicates that the pixel corresponding thereto is located in a foreground position among the depth values corresponding to the pixel data items that have the color information indicative of non-transparent colors.

4. The image mixing apparatus as claimed in claim 2 wherein said pixel mixer does not output the color information of the pixel data item, if the color information of the pixel data item indicates that the pixel is transparent, irrespective of the depth value of the pixel data item, while said pixel mixer outputs the color information of the pixel data item having the depth value which indicates that the pixel corresponding thereto is located in a foreground position among the depth values corresponding to the pixel data items that have the color information indicative of non-transparent colors.

5. The image mixing apparatus as claimed in claim 1 further comprising:
a timing generator including a first counter and operable to generate first scan count information indicative of a first scan position by the counter value of the first counter; and
a video position adjuster including a second counter, operable to generate second scan count information indicative of a second scan position with reference to the counter value of the second counter, and operable to initialize the second counter when the counter value indicated by the first scan count information matches an offset value,
wherein, at least one of said pixel output units outputs the pixel data at the output rate as set for said pixel output unit in the output timing on the basis of the first scan count information, and said other pixel output unit outputs the pixel data at the output rate as set for said other pixel output unit in the output timing on the basis of the second scan count information.

6. The image mixing apparatus as claimed in claim 2 further comprising:
a timing generator including a first counter and operable to generate first scan count information indicative of a first scan position by the counter value of the first counter; and
a video position adjuster including a second counter, operable to generate second scan count information indicative of a second scan position with reference to the counter value of the second counter, and operable to initialize the second counter when the counter value indicated by the first scan count information matches an offset value,
wherein, at least one of said pixel output units outputs the pixel data at the output rate as set for said pixel output unit in the output timing on the basis of the first scan count information, and said other pixel output unit outputs the pixel data at the output rate as set for said other pixel output unit in the output timing on the basis of the second scan count information.

7. The image mixing apparatus as claimed in claim 1 further comprising:
a timing generator including a first counter and a second counter, operable to generate first horizontal scan count information indicative of a first horizontal scan position by the counter value of the first counter, and operable to generate first vertical scan count information indicative of a first vertical scan position by the counter value of the second counter which operates on the basis of the first horizontal scan count information; and
a video position adjuster including a third counter and a fourth counter, operable to generate second horizontal scan count information indicative of a second horizontal scan position by the counter value of the third counter, operable to initialize the third counter when the counter value indicated by the first horizontal scan count information matches a horizontal offset value and generate second vertical scan count information indicative of a second vertical scan position by the counter value of the fourth counter, and operable to initialize the fourth counter when the counter value indicated by the first vertical scan count information matches a vertical offset value,
wherein, at least one of said pixel output units outputs the pixel data at the output rate as set for said pixel output unit in the output timing on the basis of the first horizontal scan count information and the first vertical scan count information, and said other pixel output unit outputs the pixel data at the output rate as set for said other pixel output unit in the output timing on the basis of the second vertical scan count information.

8. The image mixing apparatus as claimed in claim 2 further comprising:
a timing generator including a first counter and a second counter, operable to generate first horizontal scan count information indicative of a first horizontal scan position by the counter value of the first counter, and operable to generate first vertical scan count information indicative of a first vertical scan position by the counter value of the second counter which operates on the basis of the first horizontal scan count information; and
a video position adjuster including a third counter and a fourth counter, operable to generate second horizontal scan count information indicative of a second horizontal scan position by the counter value of the third counter, operable to initialize the third counter when the counter value indicated by the first horizontal scan count information matches a horizontal offset value and generate second vertical scan count information indicative of a second vertical scan position by the counter value of the fourth counter, and operable to initialize the fourth counter when the counter value indicated by the first vertical scan count information matches a vertical offset value,
wherein, at least one of said pixel output units outputs the pixel data at the output rate as set for said pixel output unit in the output timing on the basis of the first horizontal scan count information and the first vertical scan count information, and said other pixel output unit outputs the pixel data at the output rate as set for said other pixel output unit in the output timing on the basis of the second vertical scan count information.

9. The image mixing apparatus as claimed in claim 1 further comprising:
a timing generator including a first counter and operable to generate first scan count information indicative of a first scan position by the counter value of the first counter; and
a video position adjuster including a second counter, operable to generate second scan count information indicative of a second scan position by the counter value of the second counter, and operable to initialize the second counter when the counter value indicated by the first scan count information matches an offset value,
wherein, at least one of said pixel output units reads a color code designating the color information of the pixel from a first memory area in accordance with the first scan count information, converts the color code into the color information, and outputs, as the pixel data item, the color information together with the depth value at the output rate as set for said pixel output unit, and said other pixel output unit reads a color code designating the color information of the pixel from a second memory area in accordance with the second scan count information, converts the color code into the color information, and outputs, as the pixel data item, the color information together with the depth value at the output rate as set for said other pixel output unit.

10. The image mixing apparatus as claimed in claim 2 further comprising:
a timing generator including a first counter and operable to generate first scan count information indicative of a first scan position by the counter value of the first counter; and
a video position adjuster including a second counter, operable to generate second scan count information indicative of a second scan position by the counter value of the second counter, and operable to initialize the second counter when the counter value indicated by the first scan count information matches an offset value,
wherein, at least one of said pixel output units reads a color code designating the color information of the pixel from a first memory area in accordance with the first scan count information, converts the color code into the color information, and outputs, as the pixel data item, the color information together with the depth value at the output rate as set for said pixel output unit, and said other pixel output unit reads a color code designating the color information of the pixel from a second memory area in accordance with the second scan count information, converts the color code into the color information, and outputs, as the pixel data item, the color information together with the depth value at the output rate as set for said other pixel output unit.

11. The image mixing apparatus as claimed in claim 1 further comprising:
a timing generator having a first counter and a second counter, operable to generate first horizontal scan count information indicative of a first horizontal scan position by the counter value of the first counter, and generate first vertical scan count information indicative of a first vertical scan position by the counter value of the second counter which operates on the basis of the first horizontal scan count information; and
a video position adjuster having the third counter and the fourth counter, operable to generate second horizontal scan count information indicative of a second horizontal scan position by the counter, value of the third counter, operable to initialize the third counter when the counter value indicated by the first horizontal scan count information matches a horizontal offset value and generate second vertical scan count information indicative of a second vertical scan position by the counter value of the fourth counter, and operable to initialize the fourth counter when the counter value indicated by the first vertical scan count information matches a vertical offset value,
wherein, at least one of said pixel output units reads a color code for designating the color information of the pixel from a first memory area in accordance with the first horizontal scan count information and the first vertical scan count information, converts the color code into the color information, and outputs the color information, as the pixel data item, together with the depth value at the output rate as set for said pixel output unit, and said other pixel output unit reads a color code for designating the color information of the pixel from a second memory area in accordance with the second horizontal scan count information and the second vertical scan count information, converts the color code into the color information, and outputs the color information, as the pixel data item, together with the depth value at the output rate as set for said other pixel output unit.

12. The image mixing apparatus as claimed in claim 2 further comprising:
a timing generator having a first counter and a second counter, operable to generate first horizontal scan count information indicative of a first horizontal scan position by the counter value of the first counter, and generate first vertical scan count information indicative of a first vertical scan position by the counter value of the second counter which operates on the basis of the first horizontal scan count information; and
a video position adjuster having the third counter and the fourth counter, operable to generate second horizontal scan count information indicative of a second horizontal scan position by the counter value of the third counter, operable to initialize the third counter when the counter value indicated by the first horizontal scan count information matches a horizontal offset value and generate second vertical scan count information indicative of a second vertical scan position by the counter value of the fourth counter, and operable to initialize the fourth counter when the counter value indicated by the first vertical scan count information matches a vertical offset value,
wherein, at least one of said pixel output units reads a color code for designating the color information of the pixel from a first memory area in accordance with the first horizontal scan count information and the first vertical scan count information, converts the color code into the color information, and outputs the color information, as the pixel data item, together with the depth value at the output rate as set for said pixel output unit, and said other pixel output unit reads a color code for designating the color information of the pixel from a second memory area in accordance with the second horizontal scan count information and the second vertical scan count information, converts the color code into the color information, and outputs the color information, as the pixel data item, together with the depth value at the output rate as set for said other pixel output unit.

13. The image mixing apparatus as claimed in claim 1 further comprising:
a plurality of color palettes provided respectively in association with said plurality of pixel output units in order that each color palette stores a plurality of items of the color information which are associated respectively with a plurality of color codes,
wherein said pixel output unit reads the color code from a memory on the basis of scan position information, extracts the color information associated with the color code, as read, from said corresponding color palette, and outputs the color information, as the pixel data item, to said pixel mixer together with the depth value at the output rate as set for said pixel output unit.

14. The image mixing apparatus as claimed in claim 2 further comprising:
a plurality of color palettes provided respectively in association with said plurality of pixel output units in order that each color palette stores a plurality of items of the color information which are associated respectively with a plurality of color codes,
wherein said pixel output unit reads the color code from a memory on the basis of scan position information, extracts the color information associated with the color code, as read, from said corresponding color palette, and outputs the color information, as the pixel data item, to said pixel mixer together with the depth value at the output rate as set for said pixel output unit.

15. The image mixing apparatus as claimed in claim 7 wherein said pixel output unit comprising:
a first register operable to store a value which is used to adjust the horizontal position of the image on the display screen;
a second register operable to store a value which is used to set a pixel resolution in the horizontal direction;
a pixel clock generation circuit operable to generate a pixel clock signal of a frequency corresponding to the pixel resolution as set in said second register; and
a horizontal counter operable to perform a count operation in the clock cycle of the pixel clock signal, and indicate the horizontal position of the image on the display screen by the counter value thereof,
wherein said horizontal counter is initialized when the counter value indicated by the first horizontal scan count information matches the value stored in said first register.

16. The image mixing apparatus as claimed in claim 8 wherein said pixel output unit comprising:
a first register operable to store a value which is used to adjust the horizontal position of the image on the display screen;
a second register operable to store a value which is used to set a pixel resolution in the horizontal direction;
a pixel clock generation circuit operable to generate a pixel clock signal of a frequency corresponding to the pixel resolution as set in said second register; and
a horizontal counter operable to perform a count operation in the clock cycle of the pixel clock signal, and indicate the horizontal position of the image on the display screen by the counter value thereof,
wherein said horizontal counter is initialized when the counter value indicated by the first horizontal scan count information matches the value stored in said first register.

17. The image mixing apparatus as claimed in claim 11 wherein said pixel output unit comprising:
a first register operable to store a value which is used to adjust the horizontal position of the image on the display screen;
a second register operable to store a value which is used to set a pixel resolution in the horizontal direction;
a pixel clock generation circuit operable to generate a pixel clock signal of a frequency corresponding to the pixel resolution as set in said second register; and
a horizontal counter operable to perform a count operation in the clock cycle of the pixel clock signal, and indicate the horizontal position of the image on the display screen by the counter value thereof,
wherein said horizontal counter is initialized when the counter value indicated by the first horizontal scan count information matches the value stored in said first register.

18. The image mixing apparatus as claimed in claim 12 wherein said pixel output unit comprising:
a first register operable to store a value which is used to adjust the horizontal position of the image on the display screen;
a second register operable to store a value which is used to set a pixel resolution in the horizontal direction;
a pixel clock generation circuit operable to generate a pixel clock signal of a frequency corresponding to the pixel resolution as set in said second register; and
a horizontal counter operable to perform a count operation in the clock cycle of the pixel clock signal, and indicate the horizontal position of the image on the display screen by the counter value thereof,
wherein said horizontal counter is initialized when the counter value indicated by the first horizontal scan count information matches the value stored in said first register.

19. The image mixing apparatus as claimed in claim 1 wherein at least one of said pixel output units reads data in words from a memory of which one word consists of N bits (N is 2 or larger integer), extracts, on a pixel-by-pixel basis, color codes each of which represents one pixel by M bits (M is 1 or a larger integer) and which are continuously arranged in the memory without space therebetween, converts the color code as extracted into the color information, and outputs the color information to said pixel mixer together with the depth value at the output rate as set for said at least one of said pixel output units.

20. The image mixing apparatus as claimed in claim 2 wherein at least one of said pixel output units reads data in words from a memory of which one word consists of N bits (N is 2 or larger integer), extracts, on a pixel-by-pixel basis, color codes each of which represents one pixel by M bits (M is 1 or a larger integer) and which are continuously arranged in the memory without space therebetween, converts the color code as extracted into the color information, and outputs the color information to said pixel mixer together with the depth value at the output rate as set for said at least one of said pixel output units.

21. A pixel mixer operable to mix a plurality of images each of which consists of a plurality of pixels, at least two of the plurality of images having different pixel resolutions, each of the pixels being represented by a pixel value and a depth value, said pixel mixer comprising:
a pixel selection determination unit operable to successively and concurrently receive the depth values of the pixels of the plurality of images, at the rate of receiving pixels corresponding to the pixel resolution of each image whereby the rates of receiving depth values of at least two images are different, compare the depth values of the pixels, that are currently and simultaneously received, for determining which of the currently received pixels is located in the most foreground position every time at least one depth value changes, and output a select signal indicative of the currently received pixel as determined to be located in the most foreground position; and
a selector unit connected to said pixel selection determination unit, operable to successively and concurrently receive the pixel values of the pixels of the plurality of images together with the select signal in synchronization with the reception of the depth values by said pixel selection determination unit, select one of the pixel values, that are currently and simultaneously received, on the basis of the select signal, and output the pixel value as selected.
